(19) United States
(12) Patent Application Publication
(10) Pub. No.: US 2009/0317687 A1
(43) Pub. Date: Dec. 24, 2009

(54) Mixing pump device and fuel cell

(76) Inventors: Mitsuo Yokozawa, Nagano (JP); Kenji Muramatsu, Nagano (JP); Shinsuke Fukuda, Osaka (JP); Toshihiko Ichinose, Osaka (JP); Katsumi Kozu, Osaka (JP)

Correspondence Address: FLYNN THIEL BOUTELL & TANIS, P.C., 2026 RAMBLING ROAD, KALAMAZOO, MI, 49008-1631, US

(21) Appl. No.: 12/227,518

(22) PCT Filed: May 21, 2007
(86) PCT No.: PCT/JP2007/000545

§ 371 Date: Nov. 19, 2008

(30) Foreign Application Priority Data
May 22, 2006 (JP) 2006-141631
Jan. 30, 2007 (JP) 2007-019436

(51) Int. Cl. H01M 8/04; F04B 13/02; B01F 5/12

(52) U.S. Cl. 429/34; 137/565.26

(57) ABSTRACT

A mixing pump device (1) used for fuel cells etc. has two inflow paths (51, 52), inflow side active valves (21, 22) arranged at the two inflow paths (51, 52), respectively, a pump chamber (11) into which liquids flow via each of two inflow paths (51, 52), four outflow paths (61, 62, 63, 64) for allowing a liquid mixed in the pump chamber (11) to flow out, and outflow side active valves (31, 32, 33, 34) arranged at the four outflow paths (61, 62, 63, 64), respectively. Further, a chamber (82) is formed between the pump chamber (11) and a branch point (80) at which the outflow paths (61, 62, 63, 64) branch off. The construction prevents a variation in the concentration of the liquid allowed to flow out of the outflow paths (61, 62, 63, 64) after the mixing in the pump chamber (11).

### TECHNICAL FIELD

The present invention relates to a mixing pump device for mixing and feeding a plurality of liquids, and to a fuel cell that is provided with the mixing pump device as a fuel feeding device.

### BACKGROUND ART

A mixing pump device for mixing a plurality of liquids in a predetermined ratio and discharging the liquids has been proposed. As shown schematically in FIG. 24, this device has a plurality of inflow channels 51, 52; inflow-side valves (not shown) positioned in each of the inflow channels 51, 52; a pumping section 11 to which the inflow channels 51, 52 are connected; a plurality of discharge channels 61, 62, 63, 64 communicated with and directly connected to the pumping section 11; and discharge-side valves (not shown) positioned in each of the discharge channels 61, 62, 63, 64. In such a mixing pump device, liquids flowing in from the plurality of inflow channels 51, 52 are mixed together in the pumping section 11, and the mixed liquid is then discharged from the pumping section 11 through each of the plurality of discharge channels 61, 62, 63, 64 (see Patent Document 1).

[Patent Document 1]: JP-A 2006-29189

### DISCLOSURE OF THE INVENTION

### Problems to be Solved by the Invention

However, in the mixing pump device, since the pumping section 11 is filled with the liquids, the liquids cannot be stirred and mixed in the pumping section 11 merely by the action of the valve body 870 of the pump mechanism. Therefore, as indicated in the diagram in which fluctuation in the concentration of components is indicated by shading, problems occur in that a liquid mixture having a high concentration of the components that flows in from the inflow channel 51 flows out at the discharge channels 61, 62 near the inflow channel 51, for example, and the composition of the mixture flowing out from the discharge channels 61, 62, 63, 64 fluctuates. Problems also occur in that the composition varies at the start and the end of discharge from the same discharge channel. Furthermore, when the pumping section 11 is tilted in a case in which the plurality of liquids have different specific gravities, liquids having higher specific gravity stay at the bottom of the pumping section 11, and the composition of the mixture flowing out of the discharge channels 61, 62, 63, 64 fluctuates.

In view of the problems described above, an object of the present invention is to provide a mixing pump device capable of preventing fluctuation of the concentration of a liquid discharged from a plurality of discharge channels when the liquid mixed inside the pumping section is discharged from the discharge channels, and to provide a fuel cell that is provided with the mixing pump device.

### Means to Solve the Problems

In order to overcome the abovementioned problems, the present invention provides a mixing pump device having a plurality of inflow channels; inflow-side valves positioned in each of the plurality of inflow channels; a pumping section into which liquids flow via each of the plurality of inflow channels; a pump mechanism for expanding and contracting an internal volume of the pumping section; a plurality of discharge channels for discharging the liquids mixed in the pumping section; and discharge-side valves positioned in each of the plurality of discharge channels; wherein the mixing pump device is characterized in that at least one of the discharge channels from among the plurality of discharge channels is provided with a chamber whose opening has a larger cross-sectional area than in this discharge channel.

In the present invention, the liquids from each of the plurality of inflow channels flow into the pumping section, are then mixed in the pumping section, and flow out from each of the plurality of inflow channels. Because the discharge channels in this arrangement are provided with the liquid-mixing chamber, the liquids mixed in the pumping section flow out from the discharge channels via the chamber. This is accompanied by variation in the flow of liquids in the chamber. For this reason, the liquids continue to mix with each other while passing through the chamber after mixing in the pumping section even in cases in which the liquid composition varies with the position inside the pumping section. It is therefore possible to prevent the composition of the mixed liquid from varying while the liquid is in the plurality of inflow channels or between the start and the end of discharge from the same channel. Even when the orientation of the mixing pump device is tilted and a condition is established in which the components tend to become out of balance in the pumping section, the concentration of the liquid discharged from each of the discharge channels can be prevented from fluctuating.

In the present invention, the plurality of discharge channels are preferably connected to the pumping section via a shared flow channel. Through such a configuration, when the mixed liquid passes through the shared flow channel, the mixed liquid is stirred in the shared flow channel as well and is then discharged from the discharge channels. Fluctuations in concentration can therefore be prevented from occurring in the mixed liquid discharged from each of the plurality of discharge channels.

In the present invention, the chamber is preferably interposed between the pumping section and a branch point of the plurality of discharge channels. Through such a configuration, when the mixed liquid mixed in the chamber passes through the shared flow channel, the mixed liquid is stirred in the shared flow channel as well and is then discharged from the discharge channels. Fluctuations in concentration can therefore be prevented from occurring in the mixed liquid discharged from each of the plurality of discharge channels. Depending on the position in which the discharge channels are connected to the chamber, imbalance tends to be created in the outflowing mixed liquid to a greater degree than in a case in which a plurality of discharge channels are directly connected to a liquid-retaining portion such as a chamber. Fluctuations in concentration can therefore be prevented from occurring in the liquid discharged from each of the plurality of discharge channels.

In the present invention, the cross-sectional surface area of the opening at a branch point is preferably equal to or less than the larger of the cross-sectional surface area of the opening in a flow channel that leads into the branch point and the cross-sectional surface area of the opening in the discharge channels. Through such a configuration, fluctuations in concentration can be prevented from occurring in the mixed liquid discharged from each of the plurality of discharge channels because the mixed liquid does not remain at the branch point.

In the present invention, the plurality of discharge channels preferably extend horizontally from the branch point. Through such a configuration, situations are prevented in which air bubbles are discharged after collecting in a specific discharge channel among the plurality of discharge channels.

In the present invention, liquids are preferably mixed in the chamber by at least one of a turbulent flow and a circular flow generate+ d in the chamber. When a turbulent flow or a circular flow is generated in the chamber, the mixed liquid is adequately stirred and uniformly mixed in the chamber, and fluctuations in concentration can therefore be prevented from occurring in the liquid discharged from each of the plurality of discharge channels. A structure in which a baffle plate is placed in the chamber, a structure in which a helical groove or other surface irregularity is formed in an inner wall of the chamber, or a structure in which an impeller or other stirring member is placed in the chamber may be adopted in order to actively generate such a turbulent flow and/or a circular flow in the chamber. Also, a structure in which the stirring member induces movement by fluid pressure, or a structure in which movement is induced by a driving force applied from outside of the chamber can be adopted in a case in which the stirring member is placed in the chamber.

In the present invention, the chamber is preferably composed of a plurality of parts connected in series and/or in parallel.

In the present invention, exit ports to discharge liquids to the plurality of discharge channels are preferably provided to a top part of the chamber. Through such a configuration, since bubbles are easily discharged from inside the chamber, bubbles do not remain inside the chamber. Situations can therefore be avoided in which large bubbles are suddenly discharged from a specific discharge channel.

In the present invention, sharp bends are preferably not formed in the plurality of discharge channels. Bubbles readily gather in sharp bends, and accumulated bubbles separate from the inner wall of the discharge channel and discharge once a certain size is reached, but bubbles do not readily accumulate when sharp bends are not formed. Situations can therefore be avoided in which large bubbles are suddenly discharged.

In the present invention, an inside wall of the chamber is preferably subjected to a hydrophilizing treatment. Through such a configuration, since bubbles do not readily adhere to the inside wall in the chamber, situations can be avoided in which large bubbles are suddenly discharged from a discharge channel.

In the present invention, a deaeration device is preferably configured in the chamber. Through such a configuration, since bubbles are prevented from being generated inside the chamber, and situations can therefore be avoided in which bubbles are discharged from a discharge channel.

In the present invention, the plurality of inflow channels preferably communicate with the pumping section via a shared inflow space. Through such a configuration, liquids are mixed with each other in a shared inflow section before flowing into the pumping section, and then flow into the pumping section. It is therefore possible to prevent the composition of the mixed liquid from varying depending on the position inside the pumping section.

The mixing pump device according to the present invention can be used as a fuel feeding device in a fuel cell that has at least a plurality of electrical generation parts and a fuel feeding device corresponding to each of the plurality of electrical generation parts. When the mixing pump device of the present invention is used as such a fuel feeding device, fuel (mixed liquid) that is free of fluctuations in concentration can be fed to the plurality of electrical generation parts, and enhanced efficiency of electricity generation can therefore be anticipated.

### BRIEF DESCRIPTION OF THE DRAWINGS

FIG. 1(a) is a schematic block diagram showing the structure of a fuel cell that uses a mixing pump device to which the present invention is applied, and FIG. 1(b) is an external view showing the mixing pump device;

FIG. 2(a) is a schematic conceptual diagram showing the structure of the mixing pump device according to Embodiment 1 of the present invention, and FIG. 2(b) is a schematic conceptual diagram showing the structure of the discharge side of the mixing pump device;

FIG. 3 is a schematic conceptual diagram showing a transverse sectional view of the pumping section of the mixing pump device according to Embodiment 1 of the present invention;

FIGS. 4(a) and 4(b) are sectional views showing the portion of communication between the inflow channels and the pumping section of the mixing pump device according to Embodiment 1 of the present invention;

FIG. 5 is a longitudinal sectional view showing the main body portion of the mixing pump device shown in FIG. 1;

FIG. 6 is an exploded perspective view showing a state in which the reciprocating pump mechanism used in the mixing pump device shown in FIG. 1 is disassembled longitudinally;

FIG. 7 is a diagram showing a longitudinal sectional view of the inflow-side active valves and the discharge-side active valves in the mixing pump device shown in FIG. 1;

FIG. 8 is a timing chart showing the operation of the mixing pump device shown in FIG. 1;

FIGS. 9(a) through 9(h) are schematic sectional views showing examples of the structure of the chamber added to the mixing pump device of the present embodiment;

FIG. 10 is a schematic conceptual diagram showing a transverse sectional view of the pumping section according to Modification 1 of the mixing pump device to which the present invention is applied;

FIG. 11 is a schematic conceptual diagram showing a transverse sectional view of the pumping section according to Modification 2 of the mixing pump device to which the present invention is applied;

FIG. 12 is a diagram showing Structure Example 1 of a mixing device added to a mixing pump device to which the present invention is applied;

FIG. 13 is a diagram showing Structure Example 2 of a mixing device added to a mixing pump device to which the present invention is applied;

FIG. 14 is a diagram showing Structure Example 3 of a mixing device added to a mixing pump device to which the present invention is applied;

FIG. 15 is a diagram showing Structure Example 4 of a mixing device added to a mixing pump device to which the present invention is applied;

FIGS. 16(a) through 16(d) are schematic conceptual diagrams showing Improvement Example 1 of the pump mechanism of a mixing pump device to which the present invention is applied;

FIG. 17 is a schematic conceptual diagram showing Improvement Example 2 of the pump mechanism of a mixing pump device to which the present invention is applied;

FIG. 18(a) is a schematic conceptual diagram showing the structure of the mixing pump device according to Embodiment 2 of the present invention, and FIG. 18(b) is a schematic conceptual diagram showing the structure of the discharge side of the mixing pump device;

FIG. 19 is a schematic conceptual diagram showing the structure of the mixing pump device according to a modification of Embodiment 2 of the present invention;

FIG. 20 is a schematic conceptual diagram showing the structure of the mixing pump device according to Embodiment 3 of the present invention;

FIG. 21 is a schematic conceptual diagram showing the structure of the mixing pump device according to Embodiment 4 of the present invention;

FIGS. 22(a), 22(b), and 22(c) are schematic conceptual diagrams showing the structure of the mixing pump device according to Embodiment 5 of the present invention;

FIGS. 23(a) and 23(b) are schematic conceptual diagrams showing examples in which a plurality of chambers are provided in a mixing pump device to which the present invention is applied; and

FIG. 24 is a schematic conceptual diagram showing the structure of the conventional mixing pump device.

### KEY

1 mixing pump device
10 reciprocating pump mechanism
11 pumping section
21, 22 inflow-side active valves
31, 32, 33, 34 discharge-side active valves
51, 52 inflow channels
61, 62, 63, 64 discharge channels
7 shared inflow space
71 shared inflow channel
72 inflow-side chamber
81 shared discharge channel
82 discharge-side chamber
170 diaphragm valve (movable body of pump mechanism)
210, 220, 230, 240 mixing devices
270, 370, 470, 570, 670 movable members of pump mechanism
300 fuel cell
515, 517, 525, 527 inflow ports from inflow channels
815 discharge port of liquid to shared discharge space

### BEST MODE FOR CARRYING OUT THE INVENTION

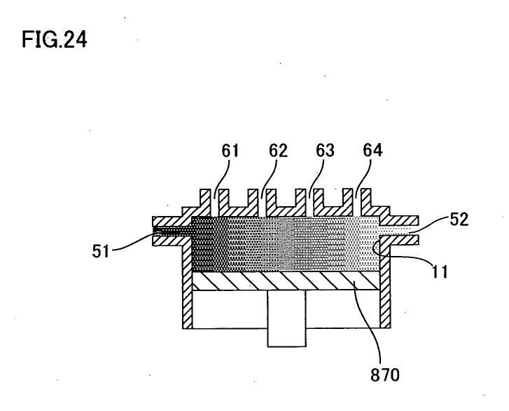

Embodiments of the present invention will next be described with reference to the drawings. So as to ensure a clear correspondence in the following description with the conventional technique shown in FIG. 24, the same reference symbols are used to refer to parts that have the same functions.

### Embodiment 1

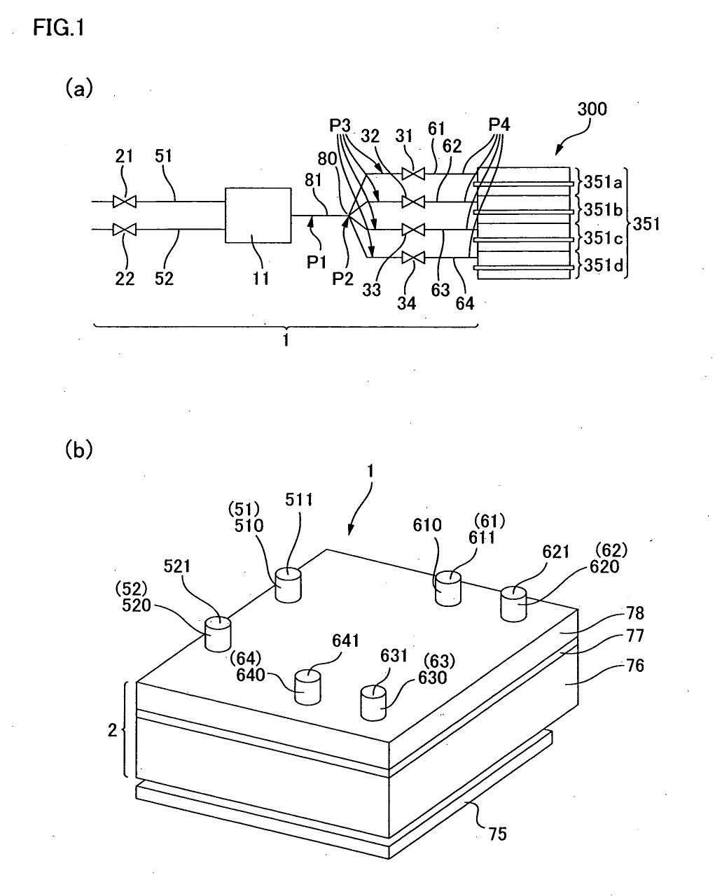

FIG. 1(a) is a schematic block diagram showing the structure of a fuel cell that uses a mixing pump device to which the present invention is applied, and FIG. 1(b) is an external view showing the mixing pump device. A plurality of discharge channels of the mixing pump device are formed according to the number of electrical generation parts of the fuel cell, but there are four electrical generation parts of the fuel cell and four discharge channels of the mixing pump device in FIGS. 1(a) and 1(b) and the description given hereinafter.

The fuel cell 300 shown in FIG. 1(a) is a direct methanol-type fuel cell for generating electricity by taking protons directly from an aqueous solution of methyl alcohol (mixed solution/fuel). In the fuel cell 300 of the present embodiment, methyl alcohol is used as raw fuel, water is used as a dilution liquid, the methyl alcohol and water are mixed by a mixing pump device 1, and a methyl alcohol aqueous solution having the optimum concentration is used as fuel. An alcohol aqueous solution having a higher concentration than the optimum concentration, e.g., a methyl alcohol aqueous solution, is also sometimes used as the raw fuel. The fuel can be any hydrogen-containing liquid that is capable of generating protons, and an ethyl alcohol aqueous solution, an ethylene glycol aqueous solution, a dimethyl ether aqueous solution, or the like may be used in addition to a methyl alcohol aqueous solution.

The fuel cell 300 of the present embodiment is provided with the mixing pump device 1 shown in FIG. 1(b), an air supply device (not shown), and electrical generation parts 351 (351a, 351b, 351c, 351d) connected to the plurality of discharge channels 61, 62, 63, 64, respectively, of the mixing pump device 1. Air is fed to the cathode electrodes of the electrical generation parts 351 (351a, 351b, 351c, 351d) from a plurality of air discharge channels (not shown) of the air supply device. Each of the plurality of electrical generation parts 351 has an anode electrode (fuel electrode) provided with an anode collector and an anode catalyst layer; a cathode (air electrode) provided with a cathode collector and a cathode catalyst layer; and an electrolyte film positioned between the anode electrode and the cathode electrode. At the anode electrode, prepared fuel (methanol aqueous solution) having a predetermined concentration is fed by the mixing pump device 1, and hydrogen ions (protons; H⁺) and electrons (e⁻) are generated by the reaction shown below.

CH₃OH+H₂O→CO₂+6H⁺+6e⁻

Electrons move from the anode electrode to the cathode electrode through a circuit or the like, hydrogen ions pass through the electrolyte film and move to the cathode electrode, and water is generated by the electrochemical reaction shown below with the air (oxygen) that is fed to the cathode electrode.

3/2O₂+6H⁺+6e⁻→3H₂O

In the fuel cell 300 thus configured, methyl alcohol and water are introduced to the pumping section 11 of the mixing pump device 1 via the inflow channels 51, 52. At this time, by setting the introduced quantity of methyl alcohol and the introduced quantity of water to a predetermined ratio, a methanol aqueous solution (fuel) having the optimum concentration is prepared, and the fuel prepared to the optimum concentration is fed to electrical generation parts 351a, 351b, 351c, 351d via the discharge channels 61, 62, 63, 64 and used to generate electricity. The discharge channels 61, 62, 63, 64 must feed fuel that is free of fluctuations in concentration. The mixing pump device 1 is therefore configured as described hereinafter in the present embodiment.

(Structure of the Mixing Pump Device)

As shown in FIG. 1(b), in the mixing pump device 1 of the present embodiment, a plurality of inflow ports and a plurality of discharge ports are formed in a main body portion 2, and an example is described herein in which two inflow ports 511, 521 and four discharge ports 611, 621, 631, 641 are formed. In this mixing pump device 1, different liquids sequentially flow into the main body portion 2 from each of the two inflow ports 511, 521, and are then mixed in the main body portion 2 and then sequentially discharged from the four discharge ports 611, 621, 631, 641.

In the main body portion 2, a bottom plate 75, a base plate 76, a flow channel formation plate 77, and a top plate 78 for blocking the top surfaces of the flow channels by covering the top surface of the flow channel formation plate 77 are layered in this sequence. Pipes 510, 520 provided with the inflow ports 511, 521, and pipes 610, 620, 630, 640 provided with the discharge ports 611, 621, 631, 641 are connected to the top plate 78; the inflow channels 51, 52 are formed by the pipes 510, 520; and the discharge channels 61, 62, 63, 64 are formed by the pipes 610, 620, 630, 640.

(Structure of the Discharge Side)

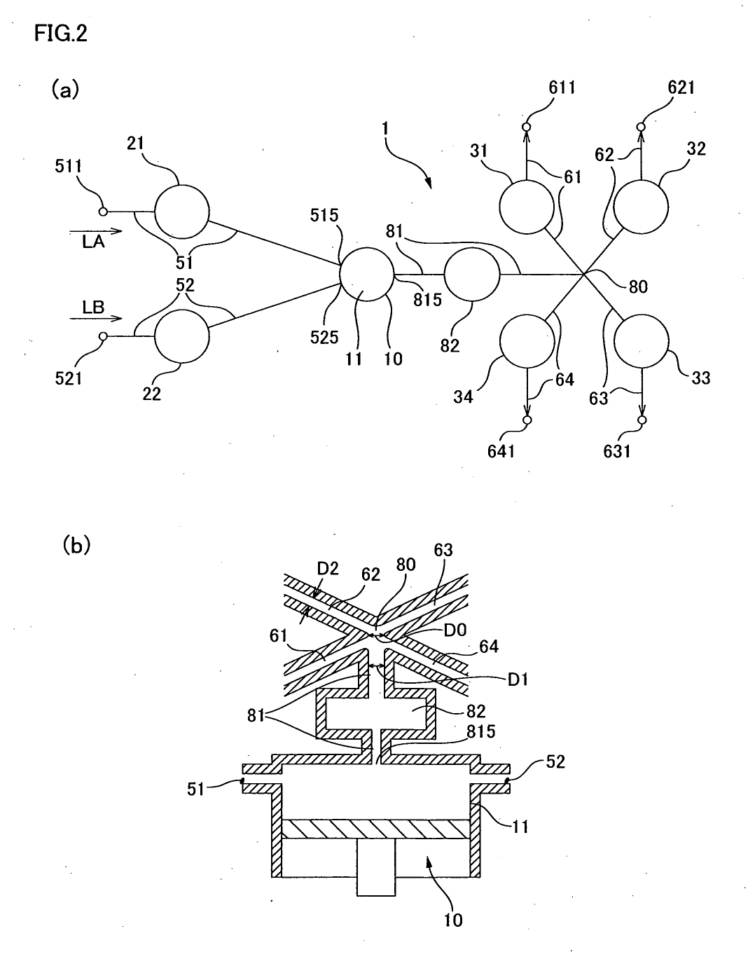

FIG. 2(a) is a schematic conceptual diagram showing the structure of the mixing pump device according to Embodiment 1 of the present invention, and FIG. 2(b) is a schematic conceptual diagram showing the structure of the discharge side of the mixing pump device.

As shown in FIGS. 1(a) and 2(a), the mixing pump device 1 of the present embodiment is provided with two inflow channels 51, 52; inflow-side active valves 21, 22 positioned in the two inflow channels 51, 52, respectively; a pumping section 11 into which the liquids flow via the two inflow channels 51, 52; a reciprocating pump mechanism 10 provided with a diaphragm, piston, or other movable body for expanding and contracting the internal volume of the pumping section 11; four discharge channels 61, 62, 63, 64 for discharging the liquid that is mixed in the pumping section 11; and discharge-side active valves 31, 32, 33, 34 positioned in the four discharge channels 61, 62, 63, 64, respectively. The two inflow channels 51, 52 each have the same length, cross-sectional surface area of the opening, and opening sectional shape; and the four discharge channels 61, 62, 63, 64 each have the same length, cross-sectional surface area of the opening, and opening sectional shape.

In the present embodiment, a shared flow channel 81 is connected to the pumping section 11. The end point of the shared flow channel 81 is the branch point 80 of the discharge channels 61, 62, 63, 64; and the discharge channels 61, 62, 63, 64 extend from the branch point 80.

The discharge channels 61, 62, 63, 64 extend horizontally from the branch point 80. The discharge channels 61, 62, 63, 64 are also arranged linearly or in a gently curving shape so that sharp bends are not formed.

A chamber 82 having a larger cross-sectional surface area of the opening than the discharge channels 61, 62, 63, 64 and the shared flow channel 81 is inserted in a midway position of the shared flow channel 81. The chamber 82 is arranged so that the liquid exit ports to the shared flow channel 81 and the discharge channels 61, 62, 63, 64 are positioned at the top thereof.

As shown in FIG. 2(b), the branch point 80 is structured so as to directly connect to the shared flow channel 81 and the discharge channels 61, 62, 63, 64; the inside diameter dimension D0 of the branch point 80 is equal to or smaller than the larger of the inside diameter dimension D1 of the entry-side flow channel (shared flow channel 81) into the branch point 80 and the inside diameter dimension D2 of the discharge channels 61, 62, 63, 64; and the cross-sectional surface area of the opening in the branch point 80 is equal to or smaller than the larger of the cross-sectional surface area of the opening in the entry-side flow channel (shared flow channel 81) into the branch point 80 and the cross-sectional surface area of the opening in the discharge channels 61, 62, 63, 64. Consequently, the branch point 80 has a small internal volume, and stagnation of liquid does not occur therein.

The discharge channels 61, 62, 63, 64 are thus communicated with the pumping section 11 via the shared flow channel 81 and the chamber 82, and a chamber 82 that is shared with respect to the discharge channels 61, 62, 63, 64 is formed between the pumping section 11 and the branch point 80 of the discharge channels 61, 62, 63, 64.

(Structure of the Pumping Section)

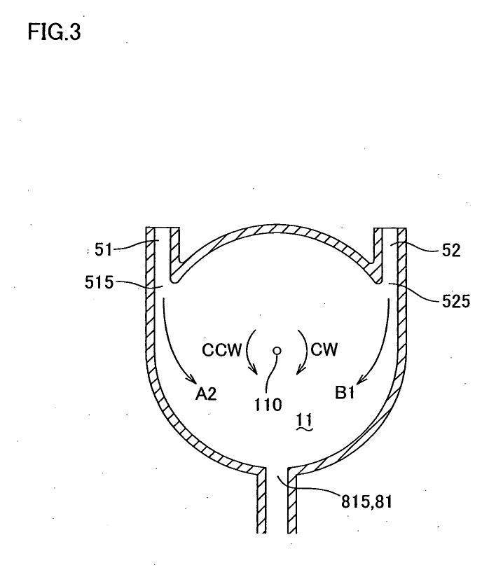

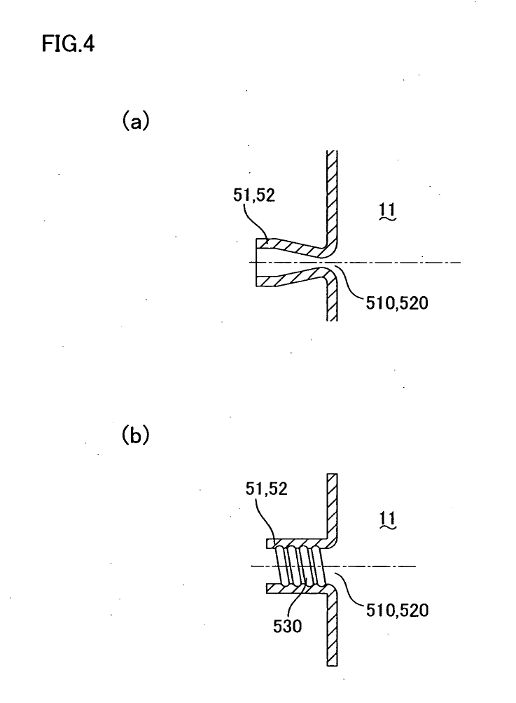

FIG. 3 is a schematic conceptual diagram showing a transverse sectional view of the pumping section of the mixing pump device according to Embodiment 1 of the present invention. FIGS. 4(a) and 4(b) are sectional views showing the portion of communication between the inflow channels and the pumping section of the mixing pump device according to Embodiment 1 of the present invention.

As shown in FIG. 3, the pumping section 11 forms a cylindrical space; and inflow ports 515, 525 of the two inflow channels 51, 52, and a liquid exit port 815 to the shared flow channel 81 are all formed in the internal peripheral wall of the pumping section 11. The liquid exit port 815 and the inflow ports 515, 525 are formed at a maximum distance from each other in the peripheral direction in the internal peripheral wall of the pumping section 11. Specifically, the inflow ports 515, 525 are positioned relatively close to each other in the internal peripheral wall of the pumping section 11, whereas the liquid exit port 815 is positioned at an angle of approximately 180° with respect to the center position of the inflow ports 515, 525.

The inflow ports 515, 525 of the inflow channels 51, 52 open so that the liquids that flow in from each of the channels are oriented in mutually opposite directions inside the pumping section 11. Specifically, the inflow port 515 of the inflow channel 51 opens in the direction whereby a liquid flows in the counterclockwise CCW direction about the center 110 of the pumping section 11, as indicated by the arrow A2; and the inflow port 525 of the inflow channel 52 opens in the direction whereby a liquid flows in the clockwise CW direction about the center 110 of the pumping section 11, as indicated by the arrow B1. The inflow ports 515, 525 of the inflow channels 51, 52 both open so that the liquids flow in along the internal peripheral wall of the pumping section 11.

In the inflow channels 51, 52 as shown in FIG. 4(a), the cross-sectional surface area of the opening in the inflow ports 510, 520 communicated with the pumping section 11 is smaller than the cross-sectional surface area of the opening in the portion positioned on the entry side, and a nozzle shape is formed. The liquid flows at high speed into the pumping section 11 from the inflow ports 510, 520. Consequently, since the liquid flowing in from the inflow channel 51 and the liquid 52 flowing in from the inflow channel 51 in the pumping section 11 create a turbulent flow and/or a circular flow inside the pumping section 11, the liquids are efficiently mixed.

In the inflow channels 51, 52, a helical groove 530 or other surface irregularity may be formed in the internal peripheral surface of the inflow ports 510, 520 communicated with the pumping section 11, as shown in FIG. 4(b). Through this configuration, the liquid flowing in from the inflow channel 51, and the liquid 52 flowing in from the inflow channel 51 in the pumping section 11 cause turbulent flow inside the pumping section 11, and are efficiently mixed.

(Specific Example of the Structure of the Reciprocating Pump Mechanism 10)

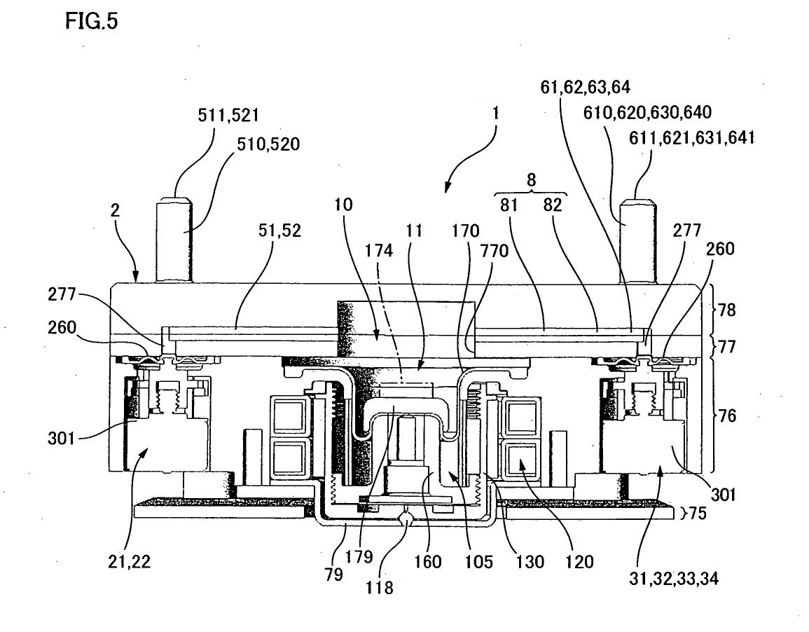

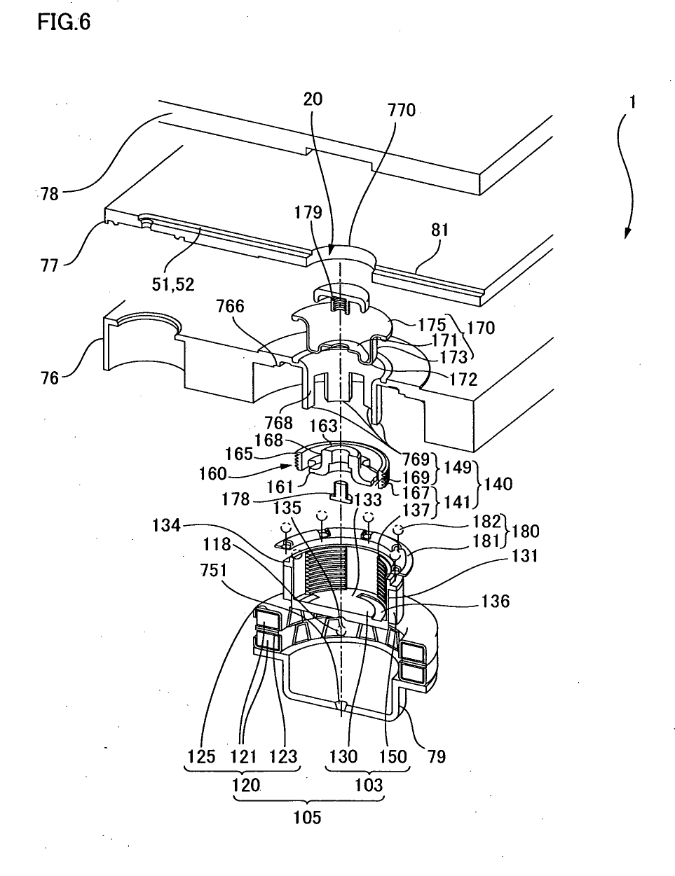

A specific example of the structure of the reciprocating pump mechanism 10 placed in the pumping section 11 in the mixing pump device 1 of the present embodiment will next be described with reference to FIGS. 5 and 6. FIG. 5 is a longitudinal sectional view showing the main body portion of the mixing pump device 1 shown in FIG. 1. FIG. 6 is an exploded perspective view showing a state in which the reciprocating pump mechanism 10 used in a mixing pump device 1 to which the present invention is applied is disassembled.

As shown in FIGS. 5 and 6, the main body portion 2 of the mixing pump device 1 of the present embodiment has a structure in which a bottom plate 75, a base plate 76, a flow channel formation plate 77, and a top plate 78 are layered in sequence. A hole constituting the pumping section 11 is formed in the base plate 76, the flow channel formation plate 77, and the top plate 78; and a reciprocating pump mechanism 10 is formed for the pumping section 11. In the present embodiment, the reciprocating pump mechanism 10 is provided with a diaphragm valve 170 (valve body/movable body) for expanding and contracting the internal volume of the pumping section 11, and for drawing in and expelling the liquid, and is also provided with a drive device 105 for driving the diaphragm valve 170.

The drive device 105 is provided with a ring-shaped stator 120; a rotor 103 concentrically placed inside the stator 120; a moving body 160 concentrically placed inside the rotor 103; and a conversion mechanism 140 for converting the rotation of the rotor 103 into a force for moving the moving body 160 in the axial direction and transmitting the force to the moving body 160. In this arrangement, the drive device 105 is mounted between the base plate 76 and a ground plate 79 in a space formed in the base plate 76.

In the drive device 105, the stator 120 has a structure in which units composed of two yokes 125 positioned so as to cover a coil 121 and a coil 121 wrapped around a bobbin 123 are layered in two levels in the axial direction. In this state, pole teeth that protrude in the axial direction from the internal peripheral edges of the two yokes 125 are alternately arranged in the peripheral direction in both of the two upper and lower units, and the stator 120 functions as a stepping motor stator.

The rotor 103 is provided with a cup-shaped member 130 that opens upward, and a ring-shaped rotor magnet 150 that is fixed to the external peripheral surface of a cylindrical core part 131 of the cup-shaped member 130. A concave part 135 that opens upward in the axial direction is formed in the center of the bottom wall 133 of the cup-shaped member 130, and a bearing part 751 for receiving a ball 118 positioned in the concave part 135 is formed in the ground plate 79. A ring-shaped step portion 766 is formed on the inside surface at the upper end of the base plate 76; a ring-shaped step portion facing the ring-shaped step portion 766 on the side of the base plate 76 is formed by the upper end portion of the core part 131 and a ring-shaped flange part 134 in the upper end portion of the cup-shaped member 130; and a bearing 180 composed of a ring-shaped retainer 181 and bearing balls 182, which are retained in a position at a distance in the peripheral direction by the retainer 181, is positioned in a ring-shaped space divided and formed by the ring-shaped step portions. The rotor 103 is thus in a state of being supported by the main body portion 2 so as to be able to rotate about the axis line.

In the rotor 103, the external peripheral surface of the rotor magnet 150 faces the pole teeth arranged in the peripheral direction along the internal peripheral surface of the stator 120. An S pole and an N pole are alternately arranged in the peripheral direction in the external peripheral surface of the rotor magnet 150, and the stator 120 and the cup-shaped member 130 constitute a stepping motor.

The moving body 160 is provided with a bottom wall 161, a cylindrical part 163 that protrudes in the axial direction from the center of the bottom wall 161, and a core part 165 formed in a cylindrical shape so as to surround the periphery of the cylindrical part 163; and a male screw 167 is formed on the external periphery of the core part 165.

In the present embodiment, to form the conversion mechanism 140 for moving the moving body 160 back and forth in the axial direction through the rotation of the rotor 103, a female screw 137 is formed in four locations spaced apart in the peripheral direction in the internal peripheral surface of the core part 131 of the cup-shaped member 130, whereas the male screw 167 for engaging with the female screw 137 of the cup-shaped member 130 to form a power transmission mechanism 141 is formed in the external peripheral surface of the core part 165 of the moving body 160. Consequently, by placing the moving body 160 on the inside of the cup-shaped member 130 so that meshing occurs between the male screw 167 and the female screw 137, the moving body 160 is supported by the inside of the cup-shaped member 130. Six elongated holes 169 are formed as through-holes in the peripheral direction in the bottom wall 161 of the moving body 160; six protrusions 769 extend from the base plate 76; and the lower end parts of the protrusions 769 fit into the elongated holes 169, whereby a co-turning prevention mechanism 149 is formed. Specifically, when the cup-shaped member 130 is rotated, the moving body 160 is prevented from rotating by the co-turning prevention mechanism 149 composed of the protrusions 769 and the elongated holes 169. Therefore, the moving body 160 moves linearly to one side and the other side in the axial direction according to the rotation direction of the rotor 103 as a result of the rotation of the cup-shaped member 130 being transmitted to the moving body 160 via the power transmission mechanism 141 composed of the female screw 137 and the male screw 167 of the moving body 160.

The diaphragm valve 170 is directly connected to the moving body 160. The diaphragm valve 170 has a cup shape provided with a bottom wall 171, a cylindrical core part 173 that rises in the axial direction from the external peripheral edge of the bottom wall 171, and a flange part 175 that extends to the external periphery from the upper edge of the core part 173; and the center portion of the bottom wall 171 is fixed to a setscrew 178 and a cap 179 from the vertical direction in a state of overhanging on the cylindrical part 163 of the moving body 160. The external peripheral edge of the flange part 175 of the diaphragm valve 170 is a thick part that functions in positioning and liquid sealing, and the thick part is fixed between the base plate 76 and the flow channel formation plate 77 on the periphery of a through-hole 770 of the flow channel formation plate 77. The diaphragm valve 170 thus defines the bottom surface of the pumping section 11 and ensures liquid-tightness between the flow channel formation plate 77 and the base plate 76 on the periphery of the pumping section 11.

In this state, the core part 173 of the diaphragm valve 170 is folded in a cross-sectional U shape, and the folded portion 172 changes shape according to the position of the moving body 160. In the present embodiment, however, the cross-sectional U-shaped folded portion 172 of the diaphragm valve 170 is positioned within the ring-shaped space formed between a first wall surface 168 composed of the external peripheral surface of the cylindrical part 163 of the moving body 160, and a second wall surface 768 composed of the internal peripheral surface of the protrusions 769 that extend from the base plate 76. Consequently, regardless of the state of the diaphragm valve 170, the folded portion 172 changes shape so as to spread or wind up along the first wall surface 168 and the second wall surface 768 while being retained inside the ring-shaped space.

A single groove 136 is formed in an angle range of 270° in the peripheral direction in the bottom wall 133 of the cup-shaped member 130, and a protrusion (not shown) is formed that extends downward from the bottom surface of the moving body 160. The moving body 160 moves in the axial direction and does not rotate about the axis, and the rotor 103 rotates about the axis, but does not move in the axial direction. Consequently, the protrusion and the groove 136 function as stoppers for defining the stopping position of the rotor 103 and the moving body 160. Specifically, the depth of the groove 136 varies in the peripheral direction, and when the moving body 160 moves downward in the axial direction, the protrusion fits into the groove 136, and the end part of the groove 136 is brought into contact with the protrusion by the rotation of the rotor 103. As a result, the rotor 103 is prevented from rotating, and the stopping position of the rotor 103 and the moving body 160 is defined; i.e., the maximum expansion position of the internal volume of the diaphragm valve 170 is defined.

In the reciprocating pump mechanism 10 thus configured, the diaphragm valve 170 in the drive device 105 is driven in the direction of increasing the internal volume of the pumping section 11 when the stepping motor rotates in one direction, and the diaphragm valve 170 is driven in the direction of decreasing the internal volume of the pumping section 11 when the stepping motor rotates in the other direction. Specifically, when a current is fed to the coils 121 of the stator 120, the cup-shaped member 130 rotates, and the rotation is transmitted to the moving body 160 via the conversion mechanism 140. Consequently, the moving body 160 moves back and forth in linear fashion in the axial direction. As a result, since the diaphragm valve 170 changes shape in conjunction with the movement of the moving body 160 and expands and contracts the internal volume of the pumping section 11, the liquid flows into and is discharged from the pumping section 11.

In the reciprocating pump mechanism 10 of the present embodiment, the rotation of the rotor 103 due to the stepping motor mechanism is transmitted to the moving body 160 via the conversion mechanism 140 that uses the power transmission mechanism 141 composed of the male screw 167 and the female screw 137, and the moving body 160 to which the diaphragm valve 170 is fixed is moved back and forth in linear fashion. Therefore, since power is transmitted by the minimum necessary number of members from the drive device 105 to the diaphragm valve 170, reduced size, reduced profile, and reduced cost of the reciprocating pump mechanism 10 can be anticipated. The moving body 160 can also be fed very small distances by reducing the lead angle of the male screw 167 and the female screw 137 in the power transmission mechanism 141, or increasing the number of pole teeth of the stator. Consequently, since the volume of the pumping section 11 can be strictly controlled, fixed quantities can be discharged with high precision.

The diaphragm valve 170 is used in the present embodiment, but the folded portion 172 of the diaphragm valve 170 changes shape so as to spread or wind up along the first wall surface 168 and the second wall surface 768 while being retained inside the ring-shaped space, and forced sliding does not occur. Unnecessary loads therefore do not occur, and the diaphragm valve 170 has a long service life. The diaphragm valve 170 does not undergo significant deformation even when subjected to pressure from the liquid of the pumping section 11. Therefore, through the reciprocating pump mechanism 10 of the present embodiment, fixed quantities can be discharged with high precision, and high reliability is obtained.

Furthermore, since the rotor 103 is supported with respect to the main body portion 2 so as to be able to rotate about the axis line via the bearing balls 182, there is minimal frictional loss, and because the rotor 103 is stably retained in the axial direction, thrust in the axial direction is stable. Reduced size, enhanced durability, and enhanced discharge performance of the drive device 105 can therefore be anticipated.

In the embodiment described above, screws are used as the power transmission mechanism 141 of the conversion mechanism 140, but a cam groove may also be used. Furthermore, a cup-shaped diaphragm valve is used as the valve body in the embodiment described above, but a diaphragm valve having another shape, or a piston provided with an O-ring may also be used.

(Specific Example of the Structure of the Active Valve)

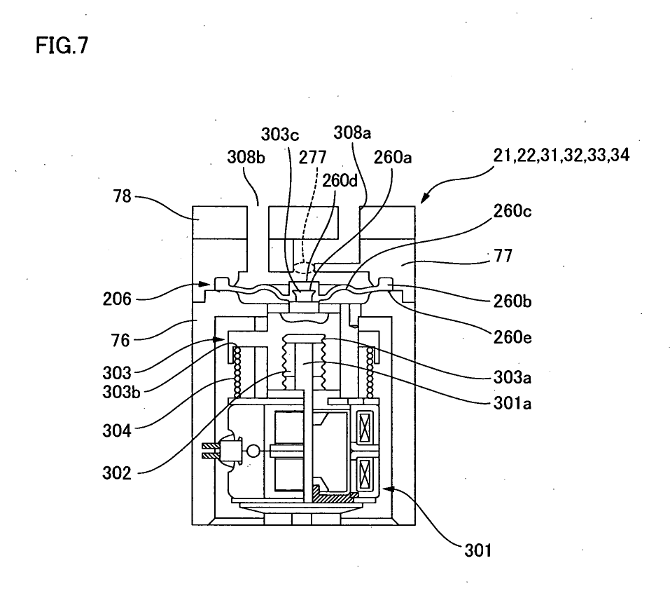

A specific example of the structure of the inflow-side active valves 21, 22 and the discharge-side active valves 31, 32, 33, 34 used in the mixing pump device of the present embodiment will be described with reference to FIGS. 5 and 7. FIG. 7 is a diagram showing a longitudinal sectional view of the inflow-side active valves 21, 22 and the discharge-side active valves 31, 32, 33, 34 in the mixing pump device 1 to which the present invention is applied.

In FIGS. 5 and 7, the inflow-side active valves 21, 22 and the discharge-side active valves 31, 32, 33, 34 all have the same structure, and are each provided with a stepping motor 301 as a drive source. A lead screw 302 composed of a right-hand screw, for example, is press fitted and fixed to a rotary shaft 301a of the stepping motor 301, and the lead screw 302 rotates in the same direction as the rotation direction of the stepping motor 301. A female screw 303a of a valve-retaining member 303 is threaded onto the lead screw 302. Consequently, the valve-retaining member 303 approaches the stepping motor 301 when the stepping motor 301 rotates counterclockwise, as viewed from the side of the lead screw 302, whereas the valve-retaining member 303 moves away from the stepping motor 301 when the stepping motor 301 rotates clockwise, as viewed from the side of the lead screw 302. Specifically, the rotation of the lead screw 302 is converted to longitudinal motion because the lead screw 302 and the valve-retaining member 303 engage by threading together, and the valve-retaining member 303 is prevented from rotating.

A spring-receiving part 303b is provided in concentric fashion on the external peripheral side of the valve-retaining member 303, and a spring 304 is retained by the spring-receiving part 303b and the stepping motor 301. The spring 304 is composed of a compression coil spring, and the spring 304 urges the valve-retaining member 303 in the direction away from the stepping motor 301. A compression coil spring is used in the present embodiment, but a tension coil spring, for example, may also be used. In this case, the tension coil spring may be retained on the opposite surface of the spring-receiving part 303b of the valve-retaining member 303.

A convex-shaped diaphragm-retaining part 303c is provided in the center of the valve-retaining member 303, and the diaphragm-retaining part 303c is fitted with an undercut part 260a of a diaphragm valve 260. In the diaphragm valve 260, an external peripheral part 260b is fixed between the base plate 76 and the flow channel formation plate 77, and a bead 260e on the external peripheral side is also fixedly inserted. The bead 260e prevents the liquid from leaking out from the gap between the base plate 76 and the flow channel formation plate 77, and contributes to enhancing the seal properties. Since the film part 260c of the diaphragm valve 260 is easily deformed, the film part 260c is formed in an arc shape so that stress is not concentrated. In the diaphragm valve 260, a bead part 260d is also formed in concentric fashion in the portion that comes in contact with the flow channel formation plate 77 on the opposite side from the undercut part 260a.

In the inflow-side active valves 21, 22 and discharge-side active valves 31, 32, 33, 34 thus configured, the valve-retaining member 303 is urged away from the stepping motor 301 by the spring 304. Consequently, when the valve-retaining member 303 is operating in longitudinal motion, a state is maintained in which the inclined plane on the side of the stepping motor 301 in the screw part of the lead screw 302, as well as the inclined plane on the opposite side from the stepping motor 301 in the female screw 303a of the valve-retaining member 303, are in contact with each other, i.e., a state is maintained in which the lead screw 302 and the valve-retaining member 303 are engaged. In contrast, when the hole 277 is closed by the diaphragm valve 260, the urging force of the spring 304 and the counteraction received by the diaphragm valve 260 from the flow channel formation plate 77 balance each other. Consequently, a state is maintained in which the inclined plane on the side of the stepping motor 301 in the screw part of the lead screw 302, as well as the inclined plane on the opposite side from the stepping motor 301 in the female screw 303a of the valve-retaining member 303, are not in contact with each other, i.e., a state is maintained in which the lead screw 302 and the valve-retaining member 303 are disengaged while free to move. The diaphragm valve 260 can therefore be urged in the direction of closing the midway position 277 of the inflow channels 51, 52 and the discharge channels 61, 62, 63, 64 by the spring 304, and the flow channels can be reliably closed. Furthermore, a disengaged state can be ensured by reversing the stepping motor 301 within the range of the free movement space of the lead screw 302 and the valve-retaining member 303.

(Operation)

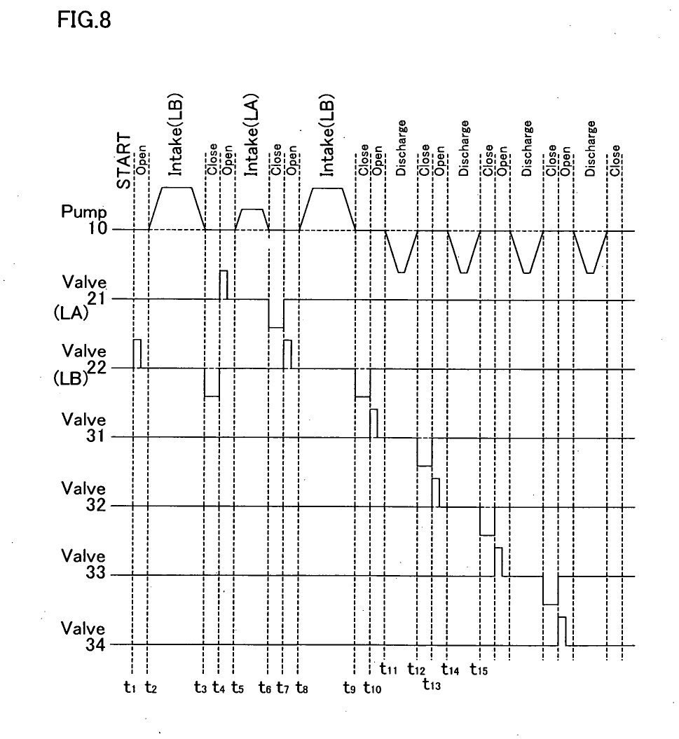

FIG. 8 is a timing chart showing the operation of the mixing pump device 1 shown in FIG. 1. In the present embodiment, the diaphragm valve 170 is driven in the direction of increasing the internal volume of the pumping section 11 when the drive device 105 (stepping motor) is rotationally driven in one direction, and the diaphragm valve 170 is driven in the direction of decreasing the internal volume of the pumping section 11 when the stepping motor rotates in the other direction. In conjunction with such operation, a control device of the mixing pump device 1 controls the opening and closing of the two inflow-side active valves 21, 22, whereby liquids sequentially drawn in from the two inflow channels 51, 52 are mixed in the pumping section 11, and then sequentially discharged from the discharge channels 61, 62, 63, 64.

The operation of the mixing pump device 1 of the present embodiment will be more specifically described with reference to FIGS. 2(a), 2(b) and 8. A case will be described in which a first liquid LA (e.g., methyl alcohol) is drawn in via the inflow channel 51 of the two inflow channels 51, 52; and a second liquid LB (e.g., water) is drawn in via the inflow channel 52. A case will be described in which the ratio (mixture ratio) of the inflow amounts of the first liquid LA and the second liquid LB is such that the mixture ratio of the first liquid LA is lower than the mixture ratio of the second liquid LB. The intake and discharge of the reciprocating pump mechanism 10 are shown at the top of FIG. 8. Intake by the reciprocating pump mechanism 10 is performed by the drive device 105 rotating clockwise, for example, and the diaphragm valve 170 moving in the direction of increasing the internal volume of the pumping section 11; and discharge by the reciprocating pump mechanism 10 is performed by the drive device 105 rotating counterclockwise, for example, and the diaphragm valve 170 moving in the direction of decreasing the internal volume of the pumping section 11. The reciprocating pump mechanism 10 is stopped by stopping the power supply to the drive device 105. The inflow-side active valves 21, 22 and the discharge-side active valves 31, 32, 33, 34 are in the open state after a positive pulse is inputted, and the valves switch to a closed state as soon as a negative pulse is inputted. The inflow-side active valves 21, 22 and the discharge-side active valves 31, 32, 33, 34 are in the closed state after a negative pulse is inputted, and the valves switch to an open state as soon as a positive pulse is inputted.

In FIG. 8, the power supply to the drive device 105 is first stopped until time t1, and the reciprocating pump mechanism 10 is in the stopped state. All of the active valves are also closed until time t1.

At time t1 in this state, only the inflow-side active valve 22 in the inflow channel that corresponds to the liquid LB among the two inflow-side active valves 21, 22 is switched to the open state. When power is supplied to the drive device 105 at time t2, and the drive device 105 rotates clockwise, the diaphragm valve 170 moves in the direction of increasing the internal volume of the pumping section 11, and the liquid LB flows into the pumping section 11 from the inflow channel 52. Pulses at a predetermined step increment are inputted to the drive device 105 until time t3, after which the power supply to the drive device 105 is stopped at time t3, and the diaphragm valve 170 then stops. At the same time, the inflow-side active valve 22 switches from open to closed. As a result, the inflow of the liquid LB from the inflow channel 22 to the pumping section 11 stops. Liquid LB is thereby caused to flow into the pumping section 11 in an amount equal to ½ the entire amount.

Then, at time t4, only the inflow-side active valve 21 switches to the open state, power is supplied to the drive device 105 at time t5, and the drive device 105 rotates clockwise, whereupon the diaphragm valve 170 moves in the direction of increasing the internal volume of the pumping section 11, and the liquid LA therefore flows into the pumping section 11 from the inflow channel 51. Pulses at a predetermined step increment are inputted to the drive device 105 until time t6, after which the power supply to the drive device 105 is stopped at time t6, and the diaphragm valve 170 then stops. At the same time, the inflow-side active valve 21 switches from open to closed. As a result, the liquid LA does not flow any longer from the inflow channel 21 into the pumping section 11. The entire quantity of the liquid LA thereby flows into the pumping section 11.

Then, at time t7, only the inflow-side active valve 22 is again switched to the open state, the power supply is fed to the drive device 105 at time t8, and the drive device 105 rotates clockwise, whereupon the diaphragm valve 170 moves in the direction of increasing the internal volume of the pumping section 11, and the liquid LB therefore flows into the pumping section 11 from the inflow channel 52. Pulses at a predetermined step increment are inputted to the drive device 105 until time t9, after which the power supply to the drive device 105 is stopped at time t9, and the diaphragm valve 170 then stops. At the same time, the inflow-side active valve 22 switches from open to closed. As a result, the liquid LB does not flow any longer from the inflow channel 22 into the pumping section 11. The remaining ½ of the entire amount of the liquid LB is thereby caused to flow into the pumping section 11, and inflow of the liquid LB is completed.

Then, at time t10, only the discharge-side active valve 31 of the four discharge-side active valves 31, 32, 33, 34 switches to the open state, the power supply is fed to the drive device 105 at time t11, and the drive device 105 rotates counterclockwise, whereupon the diaphragm valve 170 moves in the direction of decreasing the internal volume of the pumping section 11, and the mixed liquid of the pumping section 11 is discharged from the shared discharge channel 61 via a shared discharge space 8. Pulses at a predetermined step increment are inputted to the drive device 105 until time t12, after which the power supply to the drive device 105 is stopped at time t12, and the diaphragm valve 170 then stops. At the same time, the discharge-side active valve 31 switches from open to closed. The mixed liquid is thus discharged from the discharge channel 61 in an amount corresponding to ¼ the amount of the liquid that flows into the pumping section 11.

Then, at time t13, only the discharge-side active valve 32 of the two discharge-side active valves 31, 32, 33, 34 switches to the open state, the power supply is fed to the drive device 105 at time t14, and the drive device 105 rotates counterclockwise, whereupon the diaphragm valve 170 moves in the direction of decreasing the internal volume of the pumping section 11, and the mixed liquid of the pumping section 11 is discharged from the discharge channel 62 via the shared discharge space 8. Pulses at a predetermined step increment are inputted to the drive device 105 until time t15, after which the power supply to the drive device 105 is stopped at time t15, and the diaphragm valve 170 then stops. At the same time, the discharge-side active valve 32 switches from open to closed. The mixed liquid is thus discharged from the discharge channel 62 in an amount corresponding to ¼ the amount of the liquid that flows into the pumping section 11. Such an operation is performed in the same manner in the other discharge channels 63, 64, but because the details of the operation are the same, no description thereof will be given.

(Main Effects of the Present Embodiment)

As described above, liquids mixed in the pumping section 11 in the mixing pump device 1 of the present embodiment are discharged from the discharge channels 61, 62, 63, 64 after passing through the shared flow channel 81 and the chamber 82. Therefore, even when the liquid composition of the mixed liquid varies according to position within the pumping section 11, the mixed liquid is mixed while passing through the shared flow channel 81 and the chamber 82 even after being mixed in the pumping section 11. Consequently, the concentration of the mixed liquid discharged from the four discharge channels 61, 62, 63, 64 can be prevented from fluctuating. Even when the orientation of the mixing pump device 1 is tilted and a condition is established in which the components tend to become out of balance in the pumping section 11, the concentration of the liquid discharged from the discharge channels 61, 62, 63, 64 can be prevented from fluctuating.

The branch point 80 of the discharge channels 61, 62, 63, 64 is formed on the discharge side with respect to the chamber 82; the branch point 80 is structured so as to directly connect the shared flow channel 81 and the discharge channels 61, 62, 63, 64; and the cross-sectional surface area of the opening in the branch point 80 is small. Consequently, since there is no stagnation of the liquid in the branch point 80, the concentration of the mixed liquid discharged from the four discharge channels 61, 62, 63, 64 can be prevented from fluctuating.

Since the chamber 82 is positioned so that the liquid exit port thereof is at the top, air bubbles are easily expelled from the chamber 82. Situations can therefore be avoided in which large bubbles are suddenly discharged from a specific discharge channel.

The discharge channels 61, 62, 63, 64 also extend horizontally from the branch point 80. Therefore, situations are prevented in which air bubbles are discharged after collecting in a specific discharge channel among the discharge channels 61, 62, 63, 64.

The discharge channels 61, 62, 63, 64 are positioned so that sharp bends are not formed. Bubbles readily gather in sharp bends, and accumulated bubbles separate from the inner walls of the discharge channels 61, 62, 63, 64 and discharge once the bubbles reach a certain size, but bubbles do not readily accumulate when sharp bends are not formed. Situations can therefore be avoided in which large bubbles are suddenly discharged from the discharge channels 61, 62, 63, 64.

Furthermore, the inflow channels 51, 52 open so that the liquids that flow in from each of the channels are oriented in mutually opposite directions inside the pumping section 11. The flow inside the pumping section 11 therefore reverses each time the inflow of the liquid from the inflow channel 51 and the inflow of the liquid from the inflow channel 52 switch, and turbulent flow occurs. Since the inflow ports 515, 525 of the inflow channels 51, 52 open so that the liquids flow along the inside wall of the pumping section 11, circular flow occurs inside the pumping section 11. Consequently, the liquids that flow in from the inflow channels 51, 52 are stirred inside the pumping section 11 and discharged after being adequately mixed, and the concentration of the mixed liquid discharged from each of the four discharge channels 61, 62, 63, 64 can be prevented from fluctuating.

The inflow channels 51, 52 are provided with a structure that comprises the nozzle shape shown in FIG. 4(a), or the helical groove 530 shown in FIG. 4(b). Therefore, the liquids that flow in from the inflow channels 51, 52 are stirred inside the pumping section 11 and discharged after being adequately mixed, and the concentration of the mixed liquid discharged from each of the four discharge channels 61, 62, 63, 64 can be prevented from fluctuating. Specifically, since the internal volume of the pumping section 11 is considerably large in comparison with the cross-sectional surface area of the opening in the inflow channels 21, 22, the speed of the liquids entering the pumping section 11 from the inflow channels 21, 22 suddenly decreases, and stirring in the pumping section 11 is adversely affected, but when the inflow channels 21, 22 are formed in the shape of nozzles as shown in FIG. 4(a), the flow rate upon entry of the liquids can be increased, and stirring in the pumping section 11 can therefore be efficiently performed. When the helical groove 530 shown in FIG. 4(b) is formed, the liquids entering the pumping section 11 from the inflow channels 21, 22 undergo turbulent flow, and can therefore be efficiently stirred in the pumping section 11.

The liquid exit port 815 of the liquid to the shared flow channel 81 is formed at a maximum distance from the inflow ports 515, 525 in the pumping section 11. The liquids that flow into the pumping section 10 can therefore be prevented from discharging from the pumping section 10 without being adequately mixed.

Furthermore, a portion of the second liquid LB having a high mixture ratio among the first liquid LA and second liquid LB that flow in from the inflow channels 21, 22 flows into the pumping section 11 prior to flowing into the pumping section 11 of the first liquid LA having a low mixture ratio. Therefore, since the first liquid LA can be prevented from being disproportionately concentrated in a corner of the pumping section 11, e.g., the vicinity of the diaphragm valve 170, the first liquid LA and the second liquid LB can be reliably mixed together. In the present embodiment in particular, an amount of the second liquid LB having the high mixture ratio that corresponds to ½ of the total amount is drawn in, after which the first liquid LA having the low mixture ratio is drawn into the pumping section 11, and the remaining ½ of the second liquid LB is then taken into the pumping section 11. The first liquid LA and the second liquid LB can therefore be more reliably mixed together.

[Modification of the Chamber 82]

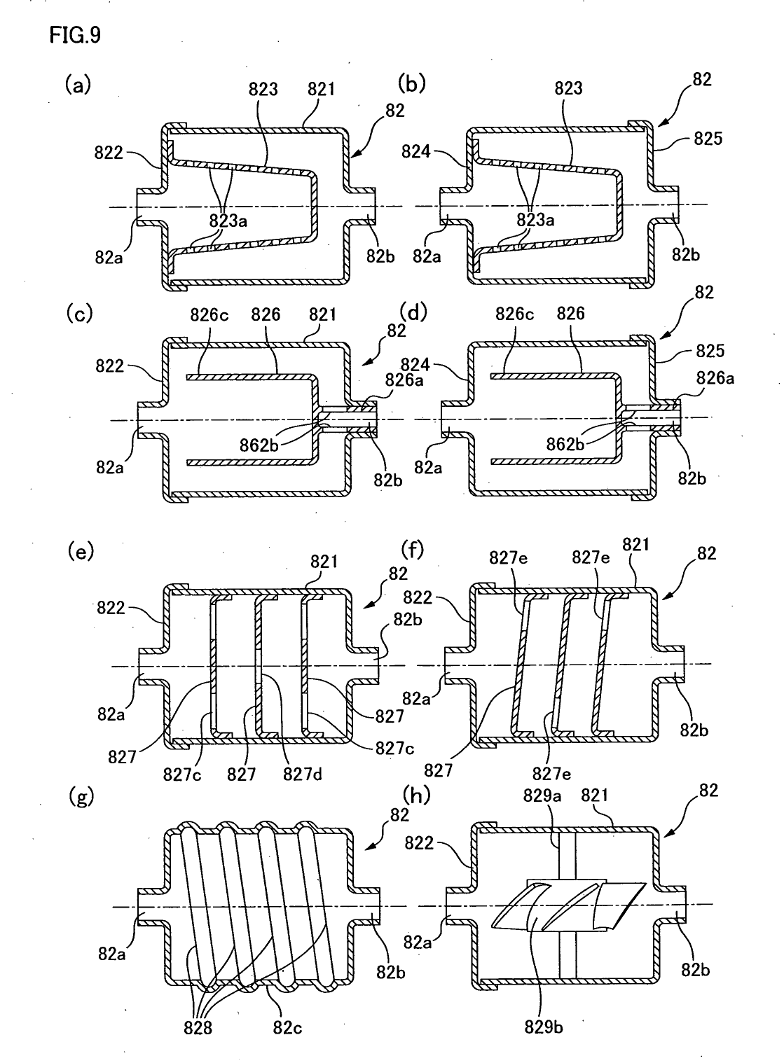

FIGS. 9(a) through 9(h) are schematic sectional views showing examples of the structure of the chamber added to the mixing pump device of the present embodiment.

In Embodiment 1 described above, the cross-sectional surface area of the opening in the chamber 82 is larger than that of the shared flow channel 81 and the discharge channels 61, 62, 63, 64, whereby the direction in which the liquid flows therein varies, and the liquid is stirred. However, as shown in FIGS. 9(a) through 9(h), a structure for actively generating a turbulent flow and/or a circular flow and efficiently stirring the liquid may also be added in the chamber 82.

The chamber 82 shown in FIG. 9(a) is composed of a cylindrical body 821 having a bottom that is positioned on the discharge side; a lid body 822 positioned on the inflow side; and a cup-shaped partition member 823 fixed to the inside surface of the lid body 822. A liquid exit port 82b is formed in the bottom part of the cylindrical body 821, and a liquid entry port 82a is formed in the center of the lid body 822. The cup-shaped partition member 823 is positioned so as to cover the liquid entry port 82a, and numerous through-holes 83a are formed in the core part thereof. Therefore, the liquid flowing into the chamber 82 from the liquid entry port 82a is discharged from the liquid exit port 82b after passing through the through-holes 823a of the partition member 823. In this instance, since the partition member 823 functions as a baffle plate, the flow of the liquid is varied by the through-holes 823a of the partition member 823, and the liquid is adequately stirred and mixed within the chamber 82. The concentration of the mixed liquid discharged from each of the discharge channels 61, 62, 63, 64 can therefore be prevented from fluctuating.

The chamber 82 is preferably positioned so that the liquid exit port 82b is positioned at the top thereof. As described regarding the inflow channels 51, 52 with reference to FIGS. 4(a) and 4(b), a structure provided with the nozzle shape shown in FIG. 4(a) or the helical groove 530 shown in FIG. 4(b) is preferably employed in the liquid entry port 82a of the chamber 82 as well. Such a structure applies in the same manner in the chamber 82 shown in FIGS. 9(b) through 9(h).

The chamber 82 shown in FIG. 9(b) is composed of a cylindrical body 824 having a bottom that is positioned on the inflow side; a lid body 825 positioned on the discharge side; and a cup-shaped partition member 823 fixed to the inside surface of the cylindrical body 824. The liquid entry port 82a is formed in the bottom part of the cylindrical body 824, and the liquid exit port 82b is formed in the center of the lid body 825. The partition member 823 is positioned so as to cover the liquid entry port 82a, and numerous through-holes 823a are formed in the core part thereof.

The chamber 82 shown in FIG. 9(c) is composed of a cylindrical body 821 having a bottom that is positioned on the discharge side; a lid body 822 positioned on the inflow side; and a cylindrical partition member 826. The liquid entry port 82a is formed in the center of the lid body 822, and the liquid exit port 82b is formed in the bottom part of the cylindrical body 821. The partition member 826 is provided with a large-diameter cylindrical part 826c and a small-diameter cylindrical part 826a, and the small-diameter cylindrical part 826a is retained by the cylindrical body 821 so as to be fitted in the liquid exit port 82b. In the partition member 826, through-holes are not formed in the large-diameter cylindrical part 826c, but numerous through holes 86b are formed in the small-diameter cylindrical part 826a. The liquid flowing into the chamber 82 from the liquid entry port 82a is therefore discharged from the liquid exit port 82b after passing through the through-holes 826b of the partition member 826. In this instance, the partition member 826 functions as a baffle plate, and the liquid is adequately stirred and mixed inside the chamber 82.

The chamber 82 shown in FIG. 9(d) is composed of a cylindrical body 824 having a bottom that is positioned on the inflow side; a lid body 825 positioned on the discharge side; and a cylindrical partition member 826. The liquid entry port 82a is formed in the bottom part of the cylindrical body 824, and the liquid exit port 82b is formed in the center of the lid body 825. The partition member 826 is provided with a large-diameter cylindrical part 826c and a small-diameter cylindrical part 826a, and the small-diameter cylindrical part 826a is retained in the lid body 825 so as to be fitted in the liquid exit port 82b. In the partition member 826, a plurality of through-holes 86b are formed in the small-diameter cylindrical part 826a.

The chamber 82 shown in FIG. 9(e) is composed of a cylindrical body 821 having a bottom that is positioned on the discharge side; a lid body 822 positioned on the inflow side; and a plurality of disk-shaped partition members 827 retained by the core part of the cylindrical body 821 in a vertical orientation and arranged in the axial direction from the liquid entry port 82a to the liquid exit port 82b. Partition members 827 in which through-holes 827c are formed on the external peripheral side, and partition members 827 in which through-holes 827d are formed on the center side are arranged in alternating fashion. The liquid flowing into the chamber 82 from the liquid entry port 82a therefore is discharged from the liquid exit port 82b after passing through the through-holes 827c, 827d of the partition members 827. In this instance, the partition members 827 function as baffle plates, and the liquid is adequately stirred and mixed inside the chamber 82.

The chamber 82 shown in FIG. 9(f) is composed of a cylindrical body 821 having a bottom that is positioned on the discharge side; a lid body 822 positioned on the inflow side; and a plurality of disk-shaped partition members 827 retained by the core part of the cylindrical body 821 in a tilted orientation and arranged in the axial direction from the liquid entry port 82a to the liquid exit port 82b. Through-holes 827e are formed on the external peripheral side in the plurality of partition members 827, and the plurality of partition members 827 are arranged so that the through-holes 827e of adjacent partition members 827 are offset in the axial direction. The liquid flowing into the chamber 82 from the liquid entry port 82a therefore is discharged from the liquid exit port 82b after passing through the through-holes 827e of the partition members 827. In this instance, the partition members 827 function as baffle plates, and the liquid is adequately stirred and mixed inside the chamber 82. Since the partition members 827 are also arranged in a tilted orientation, the liquid is directed toward the internal peripheral wall of the chamber 82. The liquid is therefore adequately stirred and mixed by the entire inside of the chamber 82.

In the chamber 82 shown in FIG. 9(g), a helical groove 828 is formed on the inner surface of the cylindrical core part 82c thereof. Circular flow (swirling current) is therefore created by the helical groove 828 in the liquid that flows into the chamber 82 from the liquid entry port 82a. Turbulent flow caused by surface irregularities of the helical groove 828 is also generated in the chamber 82. Consequently, since the liquid can be adequately stirred and mixed in the chamber 82, the concentration of the mixed liquid discharged from each of the discharge channels 61, 62, 63, 64 can be prevented from fluctuating.

The chamber 82 shown in FIG. 9(h) is provided with a cylindrical body 821 having a bottom that is positioned on the discharge side; and a lid body 822 positioned on the inflow side; and both ends of a support shaft 829a in a vertical orientation are retained in the axial direction in the core part of the cylindrical body 821. An impeller 829b (stirring member) is supported in the vicinity of the center of the support shaft 829a in the length direction thereof so as to be able to rotate about the support shaft 829a. Therefore, the liquid flowing into the chamber 82 from the liquid entry port 82a is discharged from the liquid exit port 82b while the impeller 829b is rotated. The flow of the liquid is varied by the impeller 829b, and the liquid is adequately stirred and mixed inside the chamber 82. The concentration of the mixed liquid discharged from each of the discharge channels 61, 62, 63, 64 can therefore be prevented from fluctuating.

[Modification 1 of the Pumping Section 11]

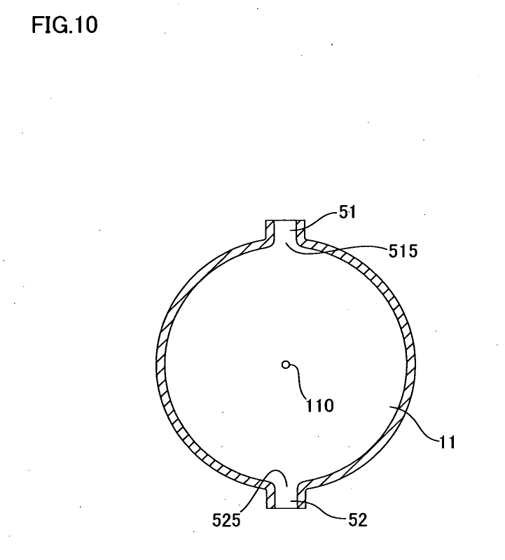

FIG. 10 is a schematic conceptual diagram showing a transverse sectional view of the pumping section according to Modification 1 of the mixing pump device to which the present invention is applied. In the embodiment as described above with reference to FIG. 3, the liquid flows in from the inflow channel 51 in the counterclockwise CCW direction, and from the inflow port 525 of the inflow channel 52 in the clockwise CW direction. However, as shown in FIG. 10, a configuration may be adopted in which the inflow channels 51, 52 are directed toward the center 110 of the pumping section 11 in a point-symmetrical position about the center 110 of the pumping section 11, or a configuration (not shown) may be adopted in which the direction of the inflow channels 51, 52 is set so as to be line-symmetrical with respect to an imaginary center line passing through the center 110 of the pumping section 11. When such a configuration is adopted, the flow inside the pumping section 11 reverses each time the inflow of the liquid from the inflow channel 51 and the inflow of the liquid from the inflow channel 52 switch, and turbulent flow occurs. Consequently, the liquids that flow in from the inflow channels 51, 52 are stirred inside the pumping section 11 and discharged after being adequately mixed. A liquid exit port is not shown in FIG. 10, but a liquid exit port is formed in the upper surface of the pumping section 11.

[Modification 2 of the Pumping Section 11]

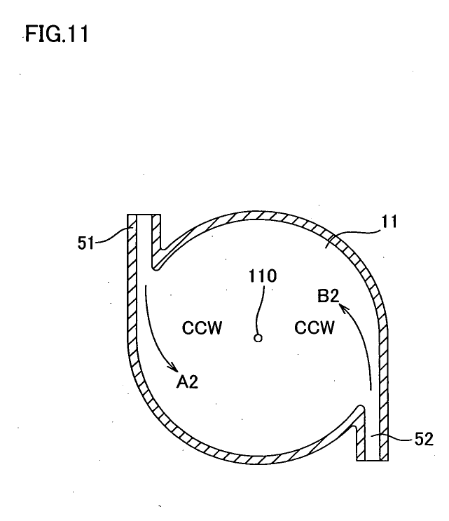

FIG. 11 is a schematic conceptual diagram showing a transverse sectional view of the pumping section according to Modification 2 of the mixing pump device to which the present invention is applied. In the example described with reference to FIGS. 3 and 10, the flow inside the pumping section 11 is reversed each time the inflow of the liquid from the inflow channel 51 and the inflow of the liquid from the inflow channel 52 switch, but in the present example, the inflow ports 515, 525 of the inflow channels 51, 52 both open so that the liquids flow in along the inner wall of the pumping section 11. In this arrangement, the inflow channel 51 opens in the direction whereby a liquid flows in the counterclockwise CCW direction about the center 110 of the pumping section 11, as indicated by the arrow A2, and the inflow port 525 of the inflow channel 52 also opens in the direction whereby a liquid flows in the counterclockwise CCW direction about the center 110 of the pumping section 11, as indicated by the arrow B2. High-speed circular flow therefore continues to occur inside the pumping section 11 even when a switch occurs between the inflow of the liquid from the inflow channel 51 and the inflow of the liquid from the inflow channel 52. Consequently, the liquids that have flowed in from the inflow channels 51, 52 are discharged after being adequately stirred and mixed inside the pumping section 11. A liquid exit port is not shown in FIG. 10, but a liquid exit port is formed in the upper surface of the pumping section 11.

### Structure Example 1 of the Mixing Device

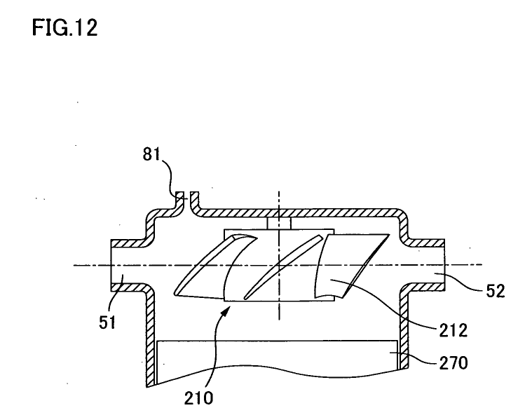

FIG. 12 is a diagram showing Structure Example 1 of a mixing device added to a mixing pump device to which the present invention is applied.

A mixing device 210 for mixing the liquids inside the pumping section 11 is configured as shown in FIG. 12 in the present example. In the present example, the mixing device 210 is formed on the pumping section 11 side among the pumping section 11 and the diaphragm, piston, or other movable body 270 for moving in the pumping section 11. Specifically, a support shaft 211 is fixed in the axial direction on the upper surface of the pumping section 11, and an impeller 212 (rotary body) is supported by the support 211 so as to be able to rotate.

In the pumping section 11 thus configured, when the movable body 270 descends linearly in the axial direction and induces inflow of the liquids from the inflow channels 51, 52 to the pumping section 11, the impeller 212 is rotated about the support shaft 211 by the pressure of the liquids. A turbulent flow and/or a circular flow is therefore generated inside the pumping section 11, and the liquids are stirred and mixed. Consequently, the liquids that have flowed in from the inflow channels 51, 52 are discharged after being stirred and adequately mixed in the pumping section 11.

It is preferred from the perspective of efficiently rotating the impeller 212 that the inflow channels 51, 52 be positioned so that the liquids collide with the distal end portion of the impeller 212. Since the impeller 212 has directionality, it is preferred from the perspective of efficiently rotating the impeller 212 that the inflow channels 51, 52 cause the liquids to flow in the same direction, as shown in FIG. 11.

### Structure Example 2 of the Mixing Device

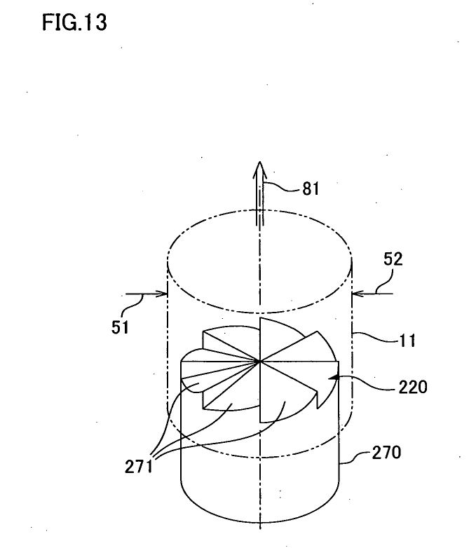

FIG. 13 is a diagram showing Structure Example 2 of a mixing device added to a mixing pump device to which the present invention is applied. In the present example, a mixing device 220 for mixing the liquid inside the pumping section 11 is configured as shown in FIG. 13. In the present example, the mixing device 220 is formed on the movable body 270 side among the pumping section 11 and the diaphragm, piston, or other movable body 270 for moving in the pumping section 11. Specifically, in the present example, blade-shaped protrusions composed of a plurality of tilted surfaces 271 inclined in the peripheral direction are formed on the upper end surface of the movable body 270. Therefore, when the movable body 270 descends linearly in the axial direction, and inflow of liquids into the pumping section 11 from the inflow channels 51, 52 occurs, the flow of the liquids varies along the tilted surfaces 271. A turbulent flow and/or a circular flow therefore occurs in the pumping section 11, and the liquids are stirred and mixed. Consequently, the liquids that have flowed in from the inflow channels 51, 52 is discharged after being stirred in the pumping section 11 and adequately mixed.

### Structure Example 3 of the Mixing Device

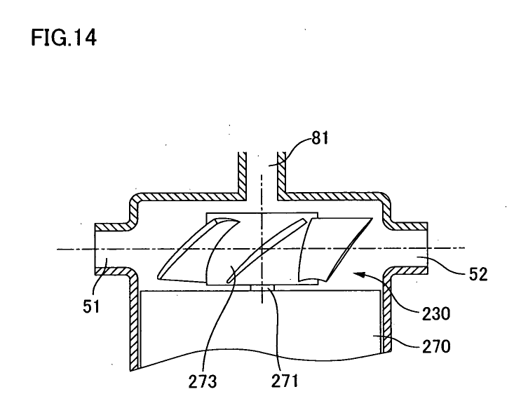

FIG. 14 is a diagram showing Structure Example 3 of a mixing device added to a mixing pump device to which the present invention is applied. A mixing device 230 for mixing the liquids inside the pumping section 11 is configured as shown in FIG. 14 in the present example. In the present example, the mixing device 220 is formed on the movable body 270 side among the pumping section 11 and the diaphragm, piston, or other movable body 270 for moving in the pumping section 11. Specifically, a support shaft 231 is fixed to the upper end surface of the movable body 270, and an impeller 232 (rotary body) is supported by the support 231 so as to be able to rotate.

In the pumping section 11 thus configured, when the movable body 270 descends linearly in the axial direction and causes the liquids to flow in from the inflow channels 51, 52 into the pumping section 11, the impeller 232 is rotated about the support shaft 231 by the pressure of the liquids. A turbulent flow and/or a circular flow therefore occurs inside the pumping section 11, and the liquids are stirred and mixed. Consequently, the liquids that have flowed in from the inflow channels 51, 52 are discharged after being stirred inside the pumping section 11 and adequately mixed.

As indicated by the dashed line in FIG. 5, blade-shaped protrusions 174 may be added to the diaphragm valve 170, cap 179, or other movable body. Through such a configuration, the blade-shaped protrusions 174 move inside the pumping section 11 in conjunction with pump operation, whereby the liquids in the pumping section are stirred, and the liquids can be efficiently mixed in the pumping section 11.

### Structure Example 4 of the Mixing Device

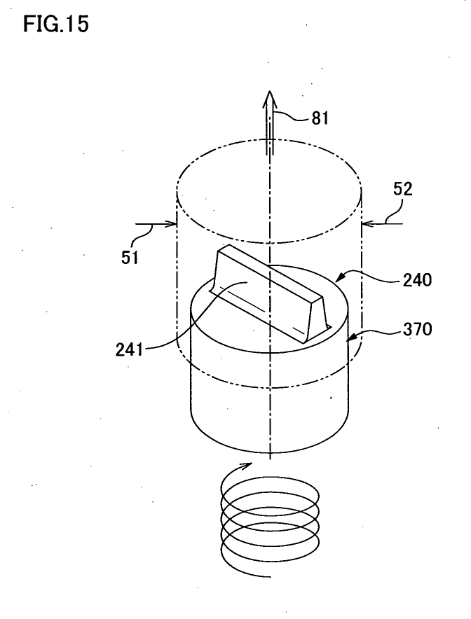

FIG. 15 is a diagram showing Structure Example 4 of a mixing device added to a mixing pump device to which the present invention is applied. A mixing device 240 for mixing the liquids inside the pumping section 11 is configured as shown in FIG. 15 in the present example. In the present example, the mixing device 220 is formed on the movable body 370 side among the pumping section 11 and the piston or other movable body 370 for moving in the pumping section 11. Specifically, a plate-shaped protrusion 241 is formed in the upper end surface of the movable body 370 so as to pass through the center position thereof. The movable body 370 moves in the axial direction while rotating about an axis line.

In the pumping section 11 thus configured, when the movable body 370 descends in the axial direction while rotating about the axis line and causes the liquids to flow into the pumping section 11 from the inflow channels 51, 52, the liquids are stirred by the protrusion 241, and circular flow occurs. Consequently, the liquids that have flowed in from the inflow channels 51, 52 are discharged after being stirred inside the pumping section 11 and adequately mixed.

### Improvement Example 1 of the Pump Mechanism 10

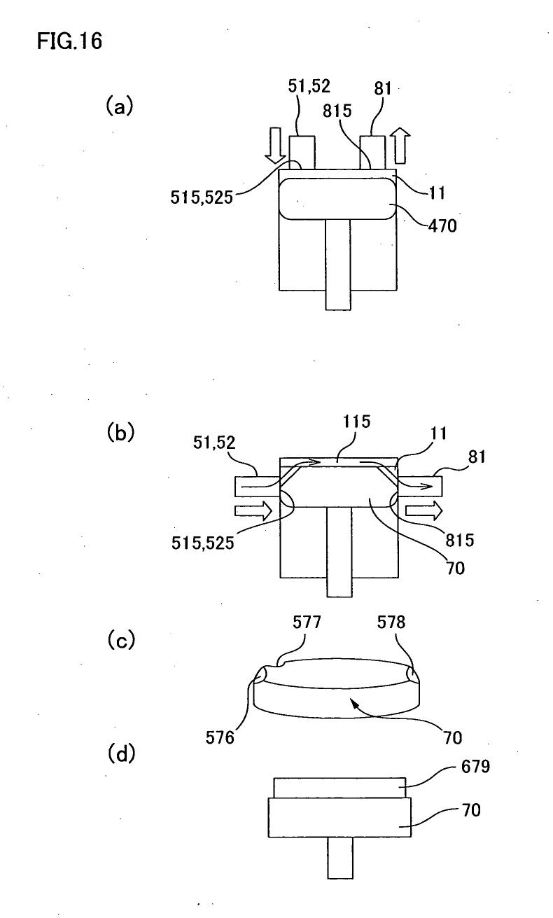

FIGS. 16(a) through 16(d) are schematic conceptual diagrams showing Improvement Example 1 of the pump mechanism of a mixing pump device to which the present invention is applied. In the present example as shown in FIG. 16(a), the inflow channels 51, 52 and the shared flow channel 81 are communicated with the pumping section 11, but the inflow channels 51, 52 and the shared flow channel 81 are communicated at the upper surface of the pumping section 11. FIG. 16(a) shows a state in which the diaphragm, piston, or other movable body 470 is at the upper dead stop point, and the inflow channels 51, 52 and the shared flow channel 81 are communicated with each other via the pumping section 11 in this state as well. Therefore, the inflow channels 51, 52 and the shared flow channel 81 are not blocked while the movable body 470 reaches the upper dead stop point. Consequently, the liquid in the pumping section 11 can be almost entirely discharged from the shared flow channel 81. Since the liquids can also be caused to flow in from the inflow channels 51, 52 merely by a slight downward movement of the movable body 470 from the upper dead stop point thereof, the liquids can be mixed in a predetermined ratio with high precision.

As shown in FIG. 16(b), the position at which the movable body 570 comes in contact with the upper surface of the pumping section 11 is the upper dead stop point, and a configuration is preferably adopted in which the inflow channels 51, 52 and the shared flow channel 81 are always communicated with each other via the pumping section 11 even when the inflow channels 51, 52 and the shared flow channel 81 are communicated by the internal peripheral wall of the pumping section 11. In order to achieve this configuration, the inflow channels 51, 52 and the shared flow channel 81 are communicated near the upper surface of the pumping section 11 as part of the internal peripheral wall of the pumping section 11, for example. A protrusion 115 is also partially formed so as to form a groove for linking the inflow channels 51, 52 and the shared flow channel 81 in the upper surface of the pumping section 11. Furthermore, in the angled portion between the upper end surface and side surface of the movable body 570 as shown in FIGS. 16(b) and 16(c), notches 576, 577, 578 are formed in the movable body 570 in positions that overlap the inflow channels 51, 52 and shared flow channel 81 when the movable body 570 is at the upper dead stop point.

In this configuration, even when the movable body 570 is at the upper dead stop point, the inflow channels 51, 52 and the shared flow channel 81 are communicated via the spaces between the notches 576, 577, 578 and the protrusion 115. Consequently, the inflow channels 51, 52 and the shared flow channel 81 are not blocked while the movable body 570 is not yet at the upper dead stop point. The liquid in the pumping section 11 can therefore be almost entirely discharged from the shared flow channel 81. Since the liquids can also be caused to flow in from the inflow channels 51, 52 merely by a slight downward movement of the movable body 570 from the upper dead stop point thereof, the liquids can be mixed in a predetermined ratio with high precision.

Even when the position at which the movable body is in surface contact with the upper surface of the pumping section 11 is the upper dead stop point, adopting the configuration shown in FIG. 16(d) makes it possible for the inflow channels 51, 52 and the shared flow channel 81 to always be communicated with each other via the pumping section 11. Specifically, the inflow channels 51, 52 and the shared flow channel 81 are communicated by the area of the pumping section 11 near the upper surface of the internal peripheral wall of the pumping section 11, and a small-diameter step portion 679 is formed on the upper end surface of the movable body 670. Through this configuration, the inflow channels 51, 52 and the shared flow channel 81 are communicated via the periphery of the small-diameter step portion 679 even when the movable body 670 is at the upper dead stop point. Consequently, the inflow channels 51, 52 and the shared flow channel 81 are not blocked while the movable body 670 is not yet at the upper dead stop point. The liquid in the pumping section 11 can therefore be almost entirely discharged from the shared flow channel 81. Since the liquids can also be caused to flow in from the inflow channels 51, 52 merely by a slight downward movement of the movable body 670 from the upper dead stop point thereof, the liquids can be mixed in a predetermined ratio with high precision.

### Improvement Example 2 of the pump mechanism 10

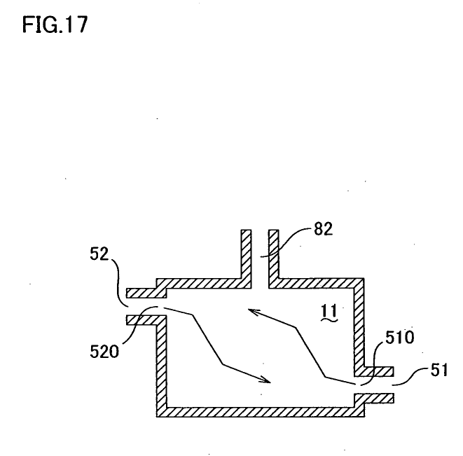

FIG. 17 is a schematic conceptual diagram showing Improvement Example 2 of the pump mechanism of a mixing pump device to which the present invention is applied. When methyl alcohol and water are caused to flow into the pumping section 11 from the inflow channels 51, 52 as in the embodiment described above, the methyl alcohol and water are difficult to mix because of the differing specific gravities thereof.

Therefore, the inflow channel 51 for flowing in methyl alcohol having a low specific gravity is communicated in a low position of the pumping section 11, and the inflow channel 52 for flowing in water having a large specific gravity is communicated in a high position of the pumping section 11 in the present example, as shown in FIG. 17.

Through this configuration, the methyl alcohol that flows into the pumping section 11 tends to rise, whereas the water that flows into the pumping section 11 tends to fall. Consequently, since a convection current occurs in the pumping section 11, the methyl alcohol that flows in from the inflow channel 51 and the water that flows in from the inflow channel 52 can be adequately mixed in the pumping section 11.

Such a configuration can be used even when there is difference in temperature between two liquids. For example, a liquid having a high temperature is caused to flow in from the inflow channel 51 communicated with the pumping section 11 in a low position, and a liquid having a low temperature is caused to flow in from the inflow channel 52 communicated with the pumping section 11 in a high position. Through this configuration, the high-temperature liquid tends to rise, whereas the low-temperature liquid tends to fall, and since a convection current occurs inside the pumping section 11 as a result, the liquids can be adequately mixed in the pumping section 11.

[Arrangement Position of the Chamber 82]

In the embodiment described above, the chamber 82 is placed in a midway position of the shared flow channel 81 as indicated by the arrow P1 in FIG. 1(a), but the chamber 82 may also be positioned at the branch point 80 of the discharge channels 61, 62, 63, 64 as indicated by the arrow P2, as in Embodiment 2 described hereinafter. The chamber 82 may be positioned further upstream than the active valves 31, 32, 33, 34 in the discharge channels 61, 62, 63, 64, as indicated by the arrows P3, and the chamber 82 may be positioned further downstream than the discharge-side active valves 31, 32, 33, 34, as indicated by the arrows P4.

In the configuration described with reference to FIG. 24, a configuration may be adopted in which the chamber 82 is inserted in a midway position of the discharge channels 61, 62, 63, 64, and in this case, it is possible to eliminated the problem of the composition varying between the start and end of discharge in the same discharge channel.

### Embodiment 2

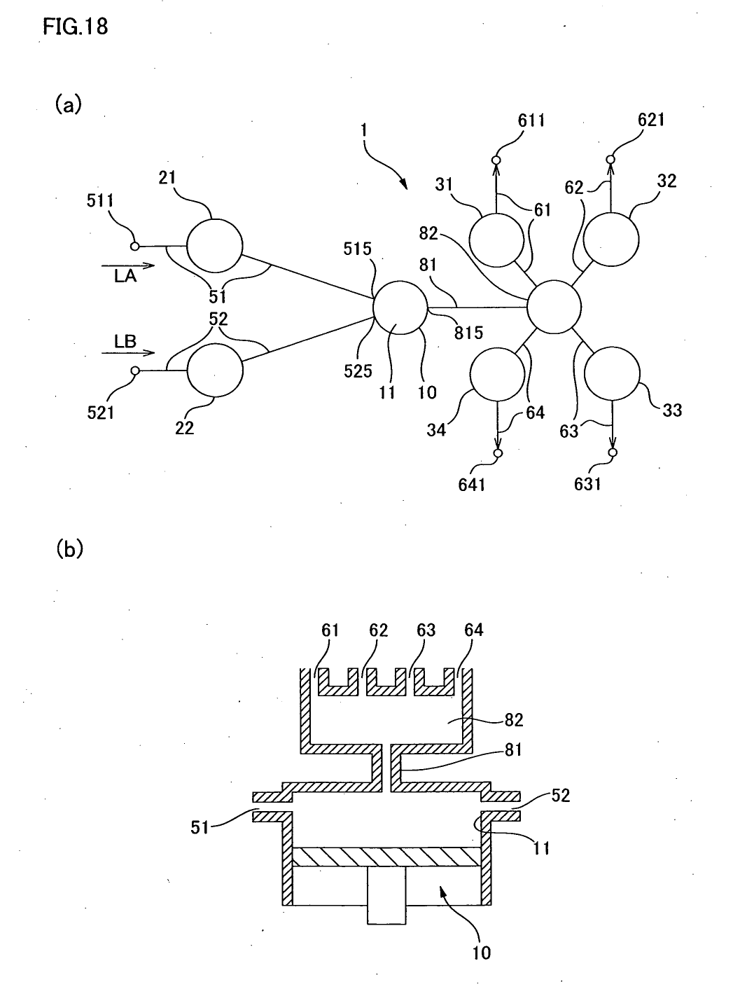

FIG. 18(a) is a schematic conceptual diagram showing the structure of the mixing pump device according to Embodiment 2 of the present invention, and FIG. 18(b) is a schematic conceptual diagram showing the structure of the discharge side of the mixing pump device. Since the basic structure of the present embodiment and of the embodiments described hereinafter is the same as that of Embodiment 1, the same reference symbols will be used to refer to the same components, and no description thereof will be given.

As shown in FIGS. 18(a) and 18(b), the mixing pump device 1 of the present embodiment is also provided with two inflow channels 51, 52; inflow-side active valves 21, 22 positioned in the two inflow channels 51, 52, respectively; a pumping section 11 into which the liquids are caused to flow in via the two inflow channels 51, 52; a reciprocating pump mechanism 10 for expanding and contracting the internal volume of the pumping section 11; four discharge channels 61, 62, 63, 64 for discharging the liquid that is mixed in the pumping section 11; and discharge-side active valves 31, 32, 33, 34 positioned in the four discharge channels 61, 62, 63, 64, respectively, the same as in Embodiment 1.

In the present embodiment, a shared flow channel 81 and a chamber 82 are communicated with each other in the pumping section 11, and the plurality of discharge channels 61, 62, 63, 64 are communicated with the pumping section 11 via the shared flow channel 81 and chamber 82. In the present embodiment, the four discharge channels 61, 62, 63, 64 are directly communicated with the chamber 82, and the chamber 82 forms the branch point of the discharge channels 61, 62, 63, 64.

The liquids mixed in the pumping section 11 are discharged from the discharge channels 61, 62, 63, 64 after passing through the shared flow channel 81 and the chamber 82 in this configuration as well. Therefore, even when the composition of the mixed liquid varies according to position within the pumping section 11, the mixed liquid is also mixed while passing through the shared flow channel 81 and chamber 82 after being mixed in the pumping section 11. Consequently, the concentration of the mixed liquid discharged from the four discharge channels 61, 62, 63, 64 can be prevented from fluctuating.

### Modification of Embodiment 2

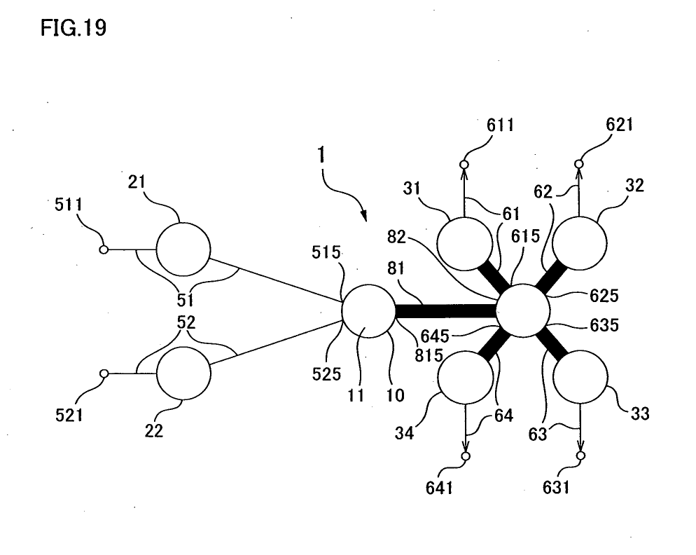

FIG. 19 is a conceptual diagram showing the structure of the mixing pump device according to a modification of Embodiment 2 of the present invention. As shown in FIG. 19, the plurality of discharge channels 61, 62, 63, 64 in the mixing pump device 1 of the present embodiment are communicated with the pumping section 11 via the shared flow channel 81 and the chamber 82, the same as in Embodiment 2. The four discharge channels 61, 62, 63, 64 are also directly communicated with the chamber 82, and the chamber 82 is the branch point of the discharge channels 61, 62, 63, 64.

In the present embodiment, the open area (discharge-side open area of the inflow channels 21, 22) in the inflow ports 515, 525 from the two inflow channels 51, 52 is narrow. For example, the cross-sectional surface area of the opening in the inflow ports 515, 525 of the two inflow channels 51, 52 is smaller than the open area of the inflow-side openings 615, 625, 635, 645 of the four discharge channels 61, 62, 63, 64, and smaller than the opening of the liquid exit port 815 of the pumping section 11. Therefore, in the present embodiment, since the flow speed of the liquid exiting from the inflow channels 21, 22 is high, stirring in the pumping section 11 can be efficiently performed. Consequently, since the liquids can be efficiently mixed in the pumping section 11, the concentration of the liquid discharged from the four discharge channels 61, 62, 63, 64 can be prevented from fluctuating.

### Embodiment 3

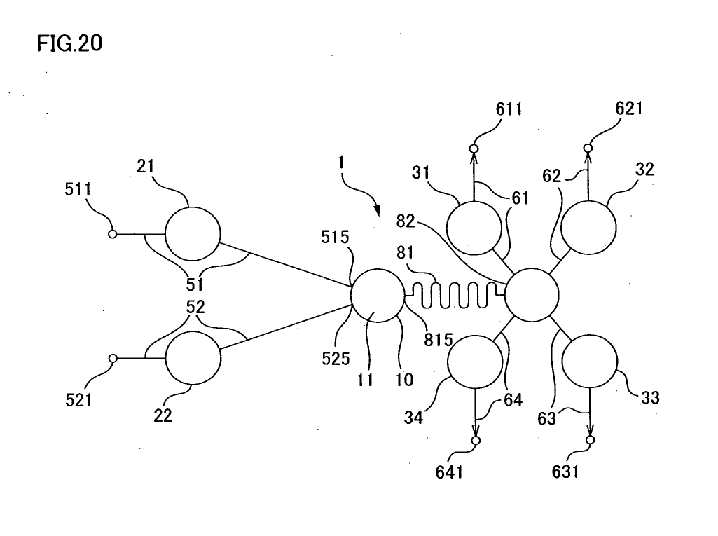

FIG. 20 is a conceptual diagram showing the structure of the mixing pump device according to Embodiment 3 of the present invention. As shown in FIG. 20, the plurality of discharge channels 61, 62, 63, 64 in the mixing pump device 1 of the present embodiment are communicated with the pumping section 11 via the shared flow channel 81 and the chamber 82, the same as in Embodiment 2. The four discharge channels 61, 62, 63, 64 are also directly communicated with the chamber 82, and the chamber 82 is the branch point of the discharge channels 61, 62, 63, 64.

In the present embodiment, the shared flow channel 81 is curved in a plurality of locations. Therefore, the liquid discharged from the pumping section 11 undergoes turbulent flow in the curved parts of the shared flow channel 81, and reaches the chamber 82 after being stirred and uniformly mixed, and the concentration of the liquid discharged from each of the four discharge channels 61, 62, 63, 64 can therefore be prevented from fluctuating. Such a configuration can also be used in the mixing pump device 1 according to Embodiment 1.

### Embodiment 4

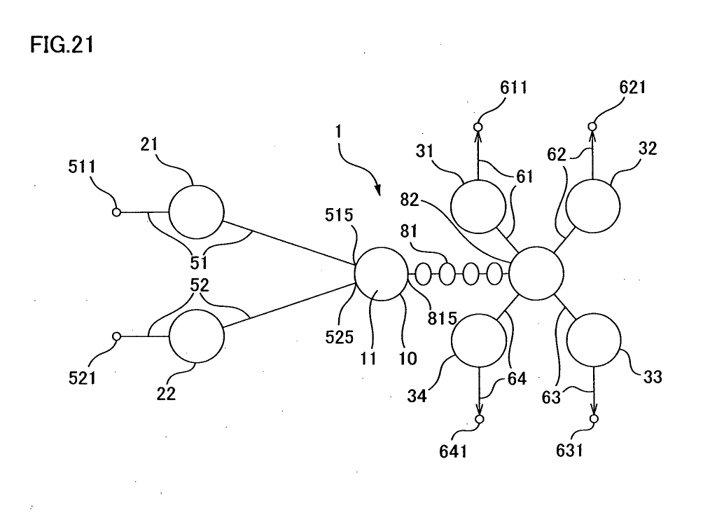

FIG. 21 is a schematic conceptual diagram showing the structure of the mixing pump device according to Embodiment 4 of the present invention. As shown in FIG. 21, the plurality of discharge channels 61, 62, 63, 64 in the mixing pump device 1 of the present embodiment are communicated with the pumping section 11 via the shared flow channel 81 and the chamber 82, the same as in Embodiment 2. The four discharge channels 61, 62, 63, 64 are also directly communicated with the chamber 82, and the chamber 82 is the branch point of the discharge channels 61, 62, 63, 64.

In the present embodiment, the flow channel is separated and joined in a plurality of locations in the length direction in the shared flow channel 81. Therefore, when the liquid discharged from the pumping section 11 passes through the shared flow channel 81, the liquid reaches the chamber 82 after being stirred and uniformly mixed by separation and joining of the flow channel, and the concentration of the liquid discharged from each of the four discharge channels 61, 62, 63, 64 can therefore be prevented from fluctuating. Such a configuration can also be used in the mixing pump device 1 according to Embodiment 1.

### Embodiment 5

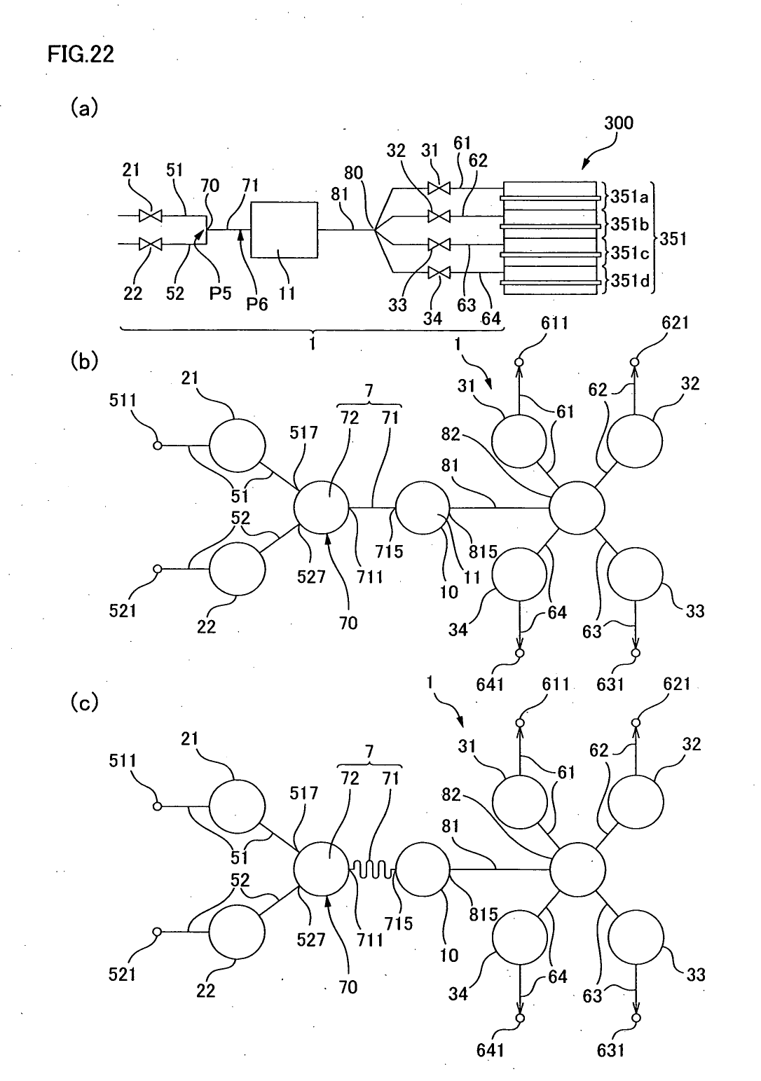

FIGS. 22(a), 22(b), and 22(c) are schematic conceptual diagrams showing the structure of the mixing pump device according to Embodiment 5 of the present invention. In the embodiments described above, the two inflow channels 51, 52 are each communicated with the pumping section 11, but a configuration may also be adopted in which the two inflow channels 51, 52 are communicated with the pumping section 11 via a shared inflow channel 71 (shared inflow space), as shown in FIG. 22(a). A configuration may be adopted in which an inflow-side chamber is positioned at the merging point 70 of the inflow channels 51, 52 as indicated by the arrow P5 in FIG. 22(a). Furthermore, a configuration may be adopted in which an inflow-side chamber is positioned midway in the shared inflow channel 71 as indicated by the arrow P6 in FIG. 22(a). Such a configuration can be combined with Embodiment 1.

A configuration in which an inflow-side chamber is placed at the merging point 70 of the inflow channels 51, 52 is shown in FIG. 22(b). The mixing pump device 1 shown in FIG. 22(b) is also provided with two inflow channels 51, 52; inflow-side active valves 21, 22 positioned in the two inflow channels 51, 52, respectively; a pumping section 11 into which the liquids are caused to flow in via the two inflow channels 51, 52; a reciprocating pump mechanism 11 for expanding and contracting the internal volume of the pumping section 11; four discharge channels 61, 62, 63, 64 for discharging the liquid that is mixed in the pumping section 11; and discharge-side active valves 31, 32, 33, 34 positioned in the four discharge channels 61, 62, 63, 64, respectively. The shared inflow channel 71 is communicated with the pumping section 11, and the two inflow channels 51, 52 are communicated with the pumping section 11 via the shared inflow channel 71. In the cylindrical pumping section 11, an inflow port 715 from the shared inflow channel, and a liquid exit port 815 for the liquid to the shared flow channel 81 are positioned at the maximum distance from each other in the peripheral direction in the internal peripheral wall of the pumping section 11.

An inflow-side chamber 72 having a larger open sectional area than the inflow channels 51, 52 is positioned at the merging point 70 of the two inflow channels 51, 52, and the two inflow channels 51, 52 are communicated with the pumping section 11 via a shared inflow space 7 that is composed of the inflow-side chamber 72 and the shared inflow channel 71. The inflow-side chamber 72 is composed of a cylindrical space, and a discharge port 711 for the liquid to the shared inflow channel 71, and inflow ports 517, 527 from the inflow channels 51, 52 (exit-side openings of the inflow channels 51, 52) are positioned at the maximum distance from each other in the peripheral direction in the internal peripheral wall of the inflow-side chamber 72.

Through such a configuration, since the liquids can be mixed together prior to flowing into the pumping section 11, the liquids can be efficiently mixed.

The shared inflow channel 71 may be curved in a plurality of locations as shown in FIG. 22(c) as well in the mixing pump device 1 shown in FIG. 22(b), and the flow channel may also be separated and joined in a plurality of locations in the length direction in the shared inflow channel 71 in the manner of Embodiment 4.

### Improvement Example of Embodiment 5

Although not shown in the drawings, a structure for connecting the pumping section 11 shown in FIG. 3, 4, 10, or 11 to the inflow channels 51, 52 may be used in the connecting structure of the inflow channels 51, 52 to the inflow-side chamber 72 in Embodiment 5.

### Other Embodiments

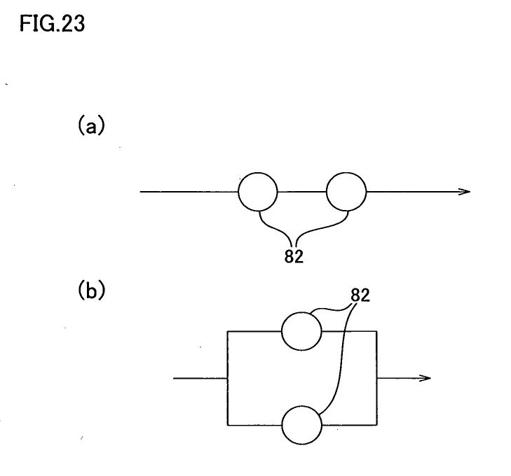

FIGS. 23(a) and 23(b) are schematic conceptual diagrams showing examples in which a plurality of chambers are provided in a mixing pump device to which the present invention is applied.

A configuration may be adopted in which a plurality of chambers 82 are connected in series as shown in FIG. 23(a), and a configuration may be adopted in which a plurality of chambers 82 are connected in parallel as shown in FIG. 23(b).

Although not shown in the drawings, a deaeration device may be formed in the discharge-side chamber 82 or the inflow-side chamber 72. Through such a configuration, air bubbles can be prevented from occurring in the liquid discharged from the discharge channels 61, 62, 63, 64. A deaeration device may be formed in at least one of the two inflow channels 51, 52. When water is fed from the inflow channel 51, and methanol is fed from the inflow channel 52, methanol has the higher gas solubility. Air bubbles therefore readily form when water and methanol are mixed together in the pumping section 11 or the shared inflow space 8, and this formation of air bubbles interferes with the discharge of specific quantities of the mixed liquid from the pumping section 11. Consequently, since the amount of dissolved gas in the methanol is reduced by providing an ultrasonic deaeration device or a deaeration device that uses a deaeration film midway in the inflow channel 52 for feeding the methanol, bubbles do not form even when water and methanol are mixed together in the pumping section 11 or the shared inflow space 8.

Furthermore, the chamber 82, the inflow-side chamber 72, or the inside wall of the pumping section 11 is preferably subjected to a hydrophilizing treatment such as plasma irradiation, coating with silica or the like, or another treatment. Through this configuration, since bubbles do not readily adhere to the inside walls of the chamber 82, the inflow-side chamber 72, or the pumping section 11, situations can be avoided in which large bubbles are suddenly discharged from the discharge channels 61, 62, 63, 64.

Examples are described in the embodiments above in which there are two inflow channels and four discharge channels, but the present invention may be applied to a mixing pump device that is provided with other numbers of inflow channels and discharge channels.

The embodiments above were described mainly using examples in which the diaphragm valve 170 was used as the diaphragm valve 170, but the present invention may be applied to a mixing pump device of a type that uses a plunger as the valve body.

[Applications of the Mixing Pump Device]

Applications of the mixing pump device 1 to which the present invention is applied are not limited to fuel cells, and the mixing pump device may be used as a pump for mixing a plurality of liquid medicines and preparing a composite medicine, for example. The mixing pump device may also be used as an ice-making pump of a freezer, and used to discharge liquid sherbets having different flavors, colors, and fragrances from a discharge channel for each block of machine-made ice.

### INDUSTRIAL APPLICABILITY

In the present invention, the liquids from each of the plurality of inflow channels flow into the pumping section, are then mixed in the pumping section, and flow out from each of the plurality of inflow channels. Because the discharge channels in this arrangement are provided with the liquid-mixing chamber, the liquids mixed in the pumping section flow out from the discharge channels via the chamber. For this reason, the liquids continue to mix with each other while passing through the chamber after mixing in the pumping section even in cases in which the liquid composition varies with the position inside the pumping section. It is therefore possible to prevent the composition of the mixed liquid from varying while the liquid is in the plurality of inflow channels or between the start and the end of discharge from the same channel. Even when the orientation of the mixing pump device is tilted and a condition is established in which the components tend to become out of balance in the pumping section, the concentration of the liquid discharged from each of the discharge channels can be prevented from fluctuating.

1. A mixing pump device having a plurality of inflow channels; inflow-side valves positioned in each of the plurality of inflow channels; a pumping section into which liquids flow via each of the plurality of inflow channels; a pump mechanism for expanding and contracting an internal volume of the pumping section; a plurality of discharge channels for discharging the liquids mixed in the pumping section; and discharge-side valves positioned in each of the plurality of discharge channels; characterized in that
at least one of the discharge channels is provided with a chamber whose opening has a larger cross-sectional area than in this discharge channel.

2. The mixing pump device according to claim 1, wherein the plurality of discharge channels are connected to the pumping section via a shared flow channel.

3. The mixing pump device according to claim 2, wherein the chamber is interposed between the pumping section and a branch point of the plurality of discharge channels.

4. The mixing pump device according to claim 3, wherein a cross-sectional surface area of an opening at the branch point is equal to or less than the larger of a cross-sectional surface area of an opening in a flow channel that leads into the branch point and a cross-sectional surface area of an opening in the discharge channels.

5. The mixing pump device according to claim 3, wherein the plurality of discharge channels extend horizontally from the branch point.

6. The mixing pump device according to claim 1, wherein liquids are mixed in the chamber by a turbulent flow and/or a circular flow generated in the chamber.

7. The mixing pump device according to claim 1, wherein a plurality of chambers are provided in a state in which they are connected in series and/or in parallel.

8. The mixing pump device according to claim 1, wherein the chamber is proved on a top part thereof with exit ports to discharge liquids to the plurality of discharge channels.

9. The mixing pump device according to claim 1, wherein each of the plurality of discharge channels has no sharp bend portions.

10. The mixing pump device according to claim 1, wherein an inside wall of the chamber is subjected to a hydrophilizing treatment.

11. The mixing pump device according to claim 1, wherein the chamber is provided with a deaeration device.

12. The mixing pump device according to claim 1, wherein the plurality of inflow channels communicate with the pumping section via a shared inflow space.

13. The mixing pump device according to claim 6, wherein a plurality of chambers are provided in a state in which they are connected in series and/or in parallel.

14. The mixing pump device according to claim 6, wherein the chamber is proved on a top part thereof with exit ports to discharge liquids to the plurality of discharge channels.

15. The mixing pump device according to claim 6, wherein each of the plurality of discharge channels has no sharp bend portions.

16. The mixing pump device according to claim 6, wherein an inside wall of the chamber is subjected to a hydrophilizing treatment.

17. The mixing pump device according to claim 6, wherein the chamber is provided with a deaeration device.

18. The mixing pump device according to claim 6, wherein the plurality of inflow channels communicate with the pumping section via a shared inflow space.

19. A fuel cell having, at least, a plurality of electrical generation parts and a mixing pump device functioning as a fuel feeding device for each of the plurality of electrical generation parts, characterized in that
the mixing pump device comprises a plurality of inflow channels; inflow-side valves positioned in each of the plurality of inflow channels; a pumping section into which liquids flow via each of the plurality of inflow channels; a pump mechanism for expanding and contracting an internal volume of the pumping section; a plurality of discharge channels for discharging the liquids mixed in the pumping section; and discharge-side valves positioned in each of the plurality of discharge channels; and
at least one of the discharge channels is provided with a chamber whose opening has a larger cross-sectional area than in the discharge channel.

20. The fuel cell according to claim 19, wherein the plurality of discharge channels are connected to the pumping section via a shared flow channel.

21. The fuel cell according to claim 20, wherein the chamber is interposed between the pumping section and a branch point of the plurality of discharge channels.

22. The fuel cell according to claim 21, wherein a cross-sectional surface area of an opening at the branch point is equal to or less than the larger of a cross-sectional surface area of an opening in a flow channel that leads into the branch point and a cross-sectional surface area of an opening in the discharge channels.

23. The fuel cell according to claim 21, wherein the plurality of discharge channels extend horizontally from the branch point.

24. The fuel cell according to claim 19, wherein liquids are mixed in the chamber by a turbulent flow and/or a circular flow generated in the chamber.

25. The fuel cell according to claim 19, wherein a plurality of chambers are provided in a state in which they are connected in series and/or in parallel.

26. The fuel cell according to claim 19, wherein the chamber is proved on a top part thereof with exit ports to discharge liquids to the plurality of discharge channels.

27. The fuel cell according to claim 19, wherein each of the plurality of discharge channels has no sharp bend portions.

28. The fuel cell according to claim 19, wherein an inside wall of the chamber is subjected to a hydrophilizing treatment.

29. The fuel cell according to claim 19, wherein the chamber is provided with a deaeration device.

30. The fuel cell according to claim 19, wherein the plurality of inflow channels communicate with the pumping section via a shared inflow space.

31. The fuel cell according to claim 24, wherein a plurality of chambers are provided in a state that they are connected in series and/or in parallel.

32. The fuel cell according to claim 24, wherein the chamber is proved on a top part thereof with exit ports to discharge liquids to the plurality of discharge channels.

33. The fuel cell according to claim 24, wherein each of the plurality of discharge channels has no sharp bend portions.

34. The fuel cell according to claim 24, wherein an inside wall of the chamber is subjected to a hydrophilizing treatment.

35. The fuel cell according to claim 24, wherein the chamber is provided with a deaeration device.

36. The fuel cell according to claim 24, wherein the plurality of inflow channels communicate with the pumping section via a shared inflow space.
